(19) United States
(12) Patent Application Publication
(10) Pub. No.: US 2026/0356014 A1
(43) Pub. Date: Nov. 12, 2026

(54) RESIN MOLDING DEVICE AND METHOD OF PRODUCING RESIN MOLDING

(71) Applicant: TOWA CORPORATION, Kyoto-shi, Kyoto (JP)

(72) Inventors: Ryuta YAGI, Kyoto-shi, Kyoto (JP); Satoshi NAKAO, Kyoto-shi, Kyoto (JP)

(73) Assignee: TOWA CORPORATION, Kyoto-shi, Kyoto (JP)

(21) Appl. No.: 19/486,019

(22) PCT Filed: Apr. 19, 2024
(86) PCT No.: PCT/JP2024/015623

§ 371 Date: Nov. 19, 2025

(30) Foreign Application Priority Data
May 25, 2023 (JP) 2023-086276

(51) Int. Cl. B29C 43/04; B29C 43/18; B29C 43/32; B29C 43/34

(52) U.S. Cl. CPC B29C 43/04; B29C 43/18; B29C 43/34; B29C 2043/3288

(57) ABSTRACT

The present invention is provided to reduce wearing to be caused by sliding of a molding die in a resin molding apparatus that slides the molding die in a sliding direction intersecting with a clamping direction, and includes a clamping mechanism that clamps a molding die via a base member, a molding die sliding mechanism that slides the molding die between a clamping position at which clamping is performed and a protruding position positioned on an outer side relative to the base member in a sliding direction intersecting with a clamping direction, and an interval changing mechanism that changes an interval between opposing surfaces of the base member and the molding die when the molding die sliding mechanism slides the molding die between the clamping position and the protruding position.

### TECHNICAL FIELD

The present invention relates to a resin molding apparatus and a resin molded product manufacturing method.

### BACKGROUND ART

Hitherto, as described in Patent Literature 1, the following compression molding apparatus has been considered. In the compression molding apparatus, a stationary molding die (a lower molding die) supported by a stationary platen is movable between a molding die clamping position and a removal position outside of the molding die. Specifically, a guide plate having a guide rail and a guide groove formed therein is provided on the stationary platen, and a slide plate supporting the stationary molding die (the lower molding die) is configured to slide along the guide rail and the guide groove of the guide plate.

### CITATION LIST

### Patent Literature

Patent Literature 1: Japanese Patent Laid-Open No. 2003-165134

### SUMMARY OF INVENTION

### Technical Problem

However, when the stationary molding die (the lower molding die) is moved between the molding die clamping position and the removal position outside of the molding die, wearing is caused between slide surfaces of the slide plate and the guide plate.

In view of the above, the present invention has been made to solve the above-mentioned problem, and has a primary object to reduce wearing to be caused by sliding of a molding die in a resin molding apparatus that slides a molding die in a sliding direction intersecting with a clamping direction.

### Solution to Problem

That is, a resin molding apparatus according to the present invention includes: a clamping mechanism that clamps a molding die via a base member; a molding die sliding mechanism that slides the molding die between a clamping position at which clamping is performed and a protruding position positioned on an outer side relative to the base member in a sliding direction intersecting with a clamping direction; and an interval changing mechanism that changes an interval between opposing surfaces of the base member and the molding die when the molding die sliding mechanism slides the molding die between the clamping position and the protruding position.

### ADVANTAGEOUS EFFECT OF INVENTION

According to the present invention having the configuration described above, in the resin molding apparatus that slides the molding die in the sliding direction intersecting with the clamping direction, the wearing to be caused by sliding of the molding die can be reduced.

### BRIEF DESCRIPTION OF DRAWINGS

FIG. 1 is a plan view schematically illustrating a configuration of a resin molding apparatus according to a first embodiment of the present invention.

FIG. 2 is a front view schematically illustrating the configuration of the resin molding apparatus of the first embodiment.

FIG. 3 is a side view schematically illustrating the configuration of the resin molding apparatus of the first embodiment.

FIG. 4 is a view schematically illustrating a configuration of a molding die of the first embodiment.

FIG. 5 is an enlarged sectional view schematically illustrating a structure around a side wall member of the first embodiment.

FIG. 6 is an enlarged view schematically illustrating a pantograph mechanism of the first embodiment.

FIG. 7 is an enlarged sectional view schematically illustrating a structure around an elastic member of the first embodiment.

FIG. 8 is a sectional view schematically illustrating an operation of the elastic member of the first embodiment.

FIG. 9 is a side view mainly illustrating a molding die sliding mechanism and an interval changing mechanism of the first embodiment.

FIG. 10 is a plan view mainly illustrating (a) a molding die sliding mechanism for an upper molding die and (b) a molding die sliding mechanism for a lower molding die of the first embodiment.

FIG. 11 is a side view illustrating a state in which the upper molding die is moved to a protruding position in the first embodiment.

FIG. 12 is a side view illustrating a state in which the lower molding die is moved to a protruding position in the first embodiment.

FIG. 13 is a side view schematically illustrating (a) an interval change between the upper molding die and a base member and (b) an interval change between the lower molding die and the base member in the first embodiment.

FIG. 14 is a flow chart of a resin molded product manufacturing method of the first embodiment.

FIG. 15 is a flow chart illustrating an operation of a substrate conveying mechanism and a sliding operation of the upper molding die in the first embodiment.

FIG. 16 is a schematic view illustrating each state of the operation of the substrate conveying mechanism and the sliding operation of the upper molding die in the first embodiment.

FIG. 17 is a flow chart illustrating an operation of a resin material conveying mechanism and a sliding operation of the lower molding die in the first embodiment.

FIG. 18 is a schematic view illustrating each state of the operation of the resin material conveying mechanism and the sliding operation of the lower molding die in the first embodiment.

FIG. 19 is a front view schematically illustrating a configuration of a resin molding apparatus according to a second embodiment.

FIG. 20 is a side view schematically illustrating the configuration of the resin molding apparatus of the second embodiment.

FIG. 21 is a side view, a sectional view, and a front view schematically illustrating a structure around an elastic member of a modification embodiment.

FIG. 22 is a front view schematically illustrating a configuration of a resin molding apparatus of a modification embodiment.

### DESCRIPTION OF EMBODIMENTS

Next, technologies according to the present invention are described in more detail by means of examples. It is to be noted that the present invention is not limited to the following technologies.

A resin molding apparatus of a first technology according to the present invention includes: a clamping mechanism that clamps a molding die via a base member; a molding die sliding mechanism that slides the molding die between a clamping position at which clamping is performed and a protruding position positioned on an outer side relative to the base member in a sliding direction intersecting with a clamping direction; and an interval changing mechanism that changes an interval between opposing surfaces of the base member and the molding die when the molding die sliding mechanism slides the molding die between the clamping position and the protruding position.

With this resin molding apparatus, when the molding die sliding mechanism slides the molding die between the clamping position and the protruding position, the interval between the opposing surfaces of the base member and the molding die is changed, and hence the opposing surfaces of the base member and the molding die can be separated at the time of sliding. As a result, wearing to be caused by the sliding of the molding die can be reduced. Further, with the molding die being moved to the protruding position, a conveying target can be conveyed for the molding die at the protruding position. As a result, it is not required to increase the interval between the molding dies at the time of unclamping, and the height of the resin molding apparatus can be reduced.

A resin molding apparatus of a second technology according to the present invention is desired to have such a configuration that, in addition to the configuration of the first technology described above, the molding die includes an upper molding die and a lower molding die, the molding die sliding mechanism is provided to correspond to each of the upper molding die and the lower molding die, and the interval changing mechanism is provided to correspond to each of the upper molding die and the lower molding die.

With this configuration, it is possible to move the upper molding die and the lower molding die to the protruding position independently of each other, and to convey the conveying target for each of the upper molding die and the lower molding die. Further, it is possible to reduce the wearing to be caused by sliding of the upper molding die and the lower molding die at this time.

A resin molding apparatus of a third technology according to the present invention is desired to have such a configuration that, in addition to the configuration of the first or second technology described above, the molding die sliding mechanism and the interval changing mechanism are configured through use of a common drive actuator.

With this configuration, the configuration of the resin molding apparatus including the molding die sliding mechanism and the interval changing mechanism can be simplified.

As a specific implementation configuring the molding die sliding mechanism and the interval changing mechanism through use of a common drive actuator, a resin molding apparatus of a fourth technology according to the present invention is desired to have such a configuration that, in addition to the configuration of the first or second technology described above, the molding die sliding mechanism includes a support frame that supports the molding die, and a drive actuator that moves the support frame in the sliding direction, the interval changing mechanism includes a cam mechanism provided to be interposed between the molding die and the base member, and the cam mechanism changes an interval between the opposing surfaces of the molding die and the base member along with movement of the support frame by the drive actuator.

With this configuration, the cam mechanism of the interval changing mechanism can be operated by the drive actuator of the molding die sliding mechanism.

A resin molding apparatus of a fifth technology according to the present invention is desired to have such a configuration that, in addition to the configuration of any one of the first to fourth technologies described above, the interval changing mechanism keeps, at the clamping position, the opposing surfaces of the molding die and the base member in a state of having a gap without bringing the opposing surfaces into contact with each other, and the opposing surfaces of the molding die and the base member come into contact with each other when the clamping mechanism performs clamping.

With this configuration, the wearing to be caused by sliding between the clamping position and the protruding position can be further reduced.

A resin molding apparatus of a sixth technology according to the present invention is desired to have such a configuration that, in addition to the configuration of any one of the first to fifth technologies described above, the molding die sliding mechanism includes a positioning portion that comes into contact with the molding die that moves toward the clamping position to position the molding die at the clamping position.

With this configuration, the positioning portion positions the molding die at the clamping position, and hence the reproducibility of the clamping position can be improved, and the quality of the resin molded product can be improved.

A resin molding apparatus of a seventh technology according to the present invention is considered to have such a configuration that, in addition to the configuration of any one of the first to sixth technologies described above, the base member includes a stationary platen, a movable platen that can be raised and lowered by the clamping mechanism, and an intermediate plate disposed between the stationary platen and the movable platen, and the molding die includes an upper molding die and a lower molding die respectively provided between the stationary platen and the intermediate plate and between the intermediate plate and the movable platen. That is, the molding die has a configuration including a plurality of sets of upper molding dies and lower molding dies.

In addition, the resin molding apparatus of the seventh technology is desired to further include a pair of side wall members disposed on both lateral sides of the movable platen and the intermediate plate, a raising-lowering sliding mechanism that slides the intermediate plate along an up-down direction relative to the pair of side wall members, and a raising-lowering interlocking mechanism that interlocks raising and lowering of the intermediate plate with raising and lowering of the movable platen, and the raising-lowering interlocking mechanism is desired to include a pantograph mechanism that includes one end portion fixed to the side wall member and another end portion that moves together with the movable platen, the pantograph mechanism expanding and contracting by the raising and lowering of the movable platen, and a coupling mechanism that couples a cross-link portion of the pantograph mechanism and the intermediate plate.

With this configuration, the number of molding dies can be increased, and the productivity of the resin molded product can be improved. Further, a plurality of intermediate plates are interlocked with the raising and lowering of the movable platen by the pantograph mechanism, and hence, even in a configuration in which the molding dies are provided between the plurality of intermediate plates, an increase in size of each member can be prevented and an increase in size of the entire device can be reduced. Thus, a high-rigidity member can be eliminated.

A resin molding apparatus of an eighth technology according to the present invention is desired to have such a configuration that, in addition to the configuration of any one of the first to seventh technologies described above, the resin molding apparatus further includes a conveying mechanism that conveys a conveying target to the molding die present at the protruding position.

A resin molding apparatus of a ninth technology according to the present invention is desired to have such a configuration that, in addition to the configuration of the eighth technology described above, the conveying mechanism includes a molding target conveying mechanism that conveys a molding target to the molding die present at the protruding position, and a resin material conveying mechanism that conveys a resin material to the molding die present at the protruding position.

A resin molding apparatus of a tenth technology according to the present invention is desired to have such a configuration that, in addition to the configuration of the ninth technology described above, the molding target conveying mechanism includes a molding target supplying unit that supplies the molding target to the molding die present at the protruding position, and a molding target receiving unit that receives the molding target subjected to resin molding from the molding die present at the protruding position.

A resin molding apparatus of an eleventh technology according to the present invention is desired to have such a configuration that, in addition to the configuration of the ninth or tenth technology described above, the resin material conveying mechanism includes a resin material supplying unit that supplies the resin material to the molding die present at the protruding position, and a film collecting unit that collects a used release film from the molding die present at the protruding position.

A resin molded product manufacturing method of manufacturing a resin molded product through use of the resin molding apparatus according to any one of the first to eleventh technologies described above, the resin molded product manufacturing method including the steps of: conveying a molding target to the molding die present at the protruding position; performing resin molding on the molding target while clamping the molding die present at the clamping position; and taking out the molding target subjected to the resin molding from the molding die present at the protruding position is also one aspect of the present invention.

### 1. First Embodiment of Present Invention

Hereinafter, a first embodiment of a resin molding apparatus according to the present invention is described with reference to the drawings.

It is to be noted that each of the figures described below is also schematically illustrated with appropriate omission or exaggeration for ease of understanding. The same components are denoted by the same reference symbols and description thereof is omitted as appropriate.

### 1-1. Overall Configuration of Resin Molding Apparatus

A resin molding apparatus 100 of the first embodiment manufactures a resin molded product P by resin-sealing an electronic component Wx fixed to a substrate W that is a molding target by resin molding using a resin material J.

Here, examples of the substrate W include a metal substrate, a resin substrate, a glass substrate, a ceramic substrate, a circuit board, a semiconductor substrate, a lead frame, a silicon wafer, and a glass wafer. In addition, the substrate W may be a carrier having no wiring. Further, examples of the resin material J include powdered resin (including granular resin) and liquid resin. Further, examples of the electronic component Wx include electronic elements such as a semiconductor chip, a resistor element, or a capacitor element, and an electronic component in a mode in which at least one of those electronic elements is resin-sealed.

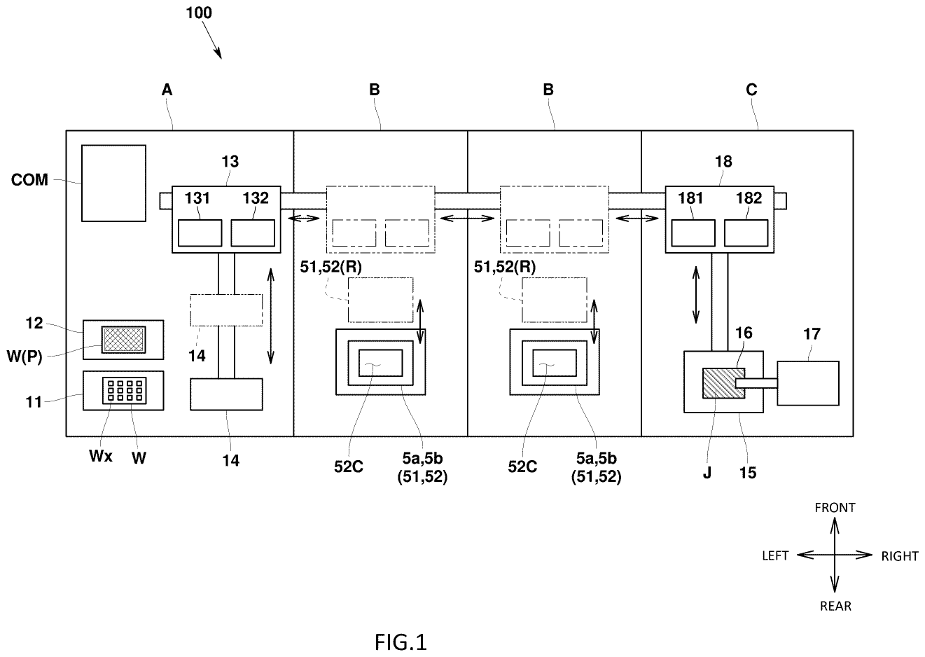

This resin molding apparatus 100 includes, as illustrated in FIG. 1, a substrate supplying and storing module A, two resin molding modules B, and a resin material supplying module C as components. Each of the components (each of the modules A to C) can be mounted to and removed from and also replaced with another one of the components.

The substrate supplying and storing module A includes a substrate receiving unit 11 that receives a pre-molding substrate W from outside, a substrate storing unit 12 that stores a molded substrate W (a resin molded product P), a substrate conveying mechanism 13 that conveys the pre-molding substrate W and the resin molded product P, and a delivery mechanism 14 such as a conveyance robot that conveys, that is, delivers the pre-molding substrate W and the resin molded product P to the substrate conveying mechanism 13.

The substrate conveying mechanism 13 conveys the pre-molding substrate W from the substrate supplying and storing module A to the resin molding module B, and, in the resin molding module B, supplies the pre-molding substrates W to molding dies 5a and 5b. After the resin molding of the pre-molding substrates W, the substrate conveying mechanism 13 receives the resin molded products P that are molded substrates W subjected to resin molding from the molding dies 5a and 5b in the resin molding module B, and conveys the resin molded products P to the substrate supplying and storing module A. Further, the delivery mechanism 14 delivers the pre-molding substrate W from the substrate receiving unit 11 to the substrate conveying mechanism 13, and delivers the resin molded product P from the substrate conveying mechanism 13 to the substrate storing unit 12.

Each of the resin molding modules B includes an upper molding die 51 that is a first molding die that holds the substrate W, and a lower molding die 52 that is a second molding die having a cavity 52C formed therein, and those molding dies are clamped so that the electronic component Wx fixed to the substrate W is resin-sealed by resin molding using the resin material J. It is to be noted that the specific configuration of the resin molding module B is described later.

The resin material supplying module C includes a moving table 15, a resin material storing unit 16 placed on the moving table 15, a resin material loading mechanism 17 that measures the resin material J and loads the resin material J to the resin material storing unit 16, and a resin material conveying mechanism 18 that conveys the resin material storing unit 16 to supply the resin material J into the cavity 52C of the lower molding die 52. Here, the resin material storing unit 16 is configured by using a holding frame that holds a mold release film F, and the resin material loading mechanism 17 loads the resin material J onto the mold release film F held on the holding frame.

The moving table 15 moves, in the resin material supplying module C, between a resin loading position at which resin is loaded by the resin material loading mechanism 17 and a conveying position at which the resin material storing unit 16 is delivered to the resin material conveying mechanism 18. Further, the resin material conveying mechanism 18 conveys the resin material storing unit 16 storing the resin material J from the resin material supplying module C to the resin molding module B, and, in the resin molding module B, supplies the mold release films F and the resin materials J to the molding dies 5a and 5b. After that, the resin material conveying mechanism 18 conveys the resin material storing unit 16 after supplying the resin material J from the resin molding module B to the resin material supplying module C.

### 1-2. Specific Configuration of Resin Molding Module B

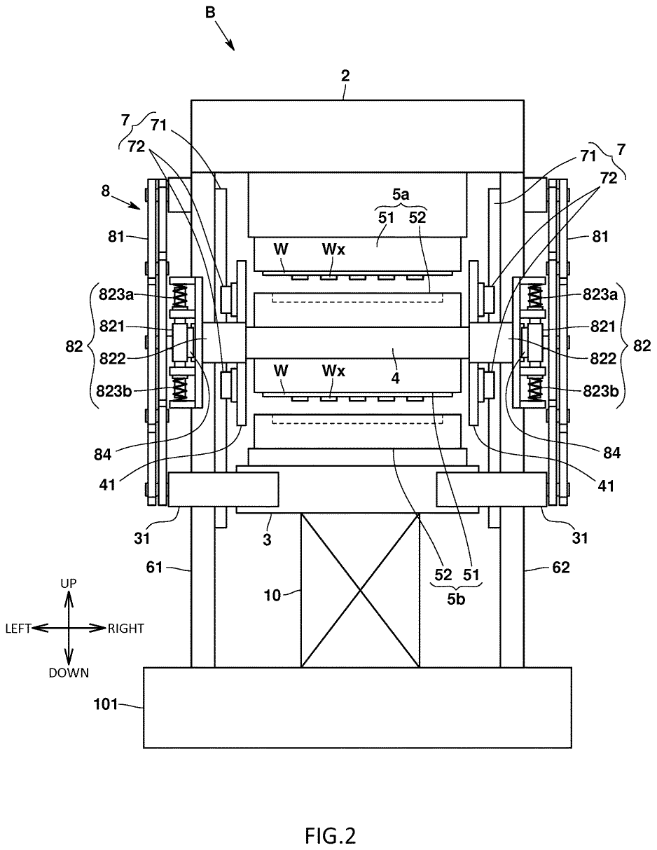

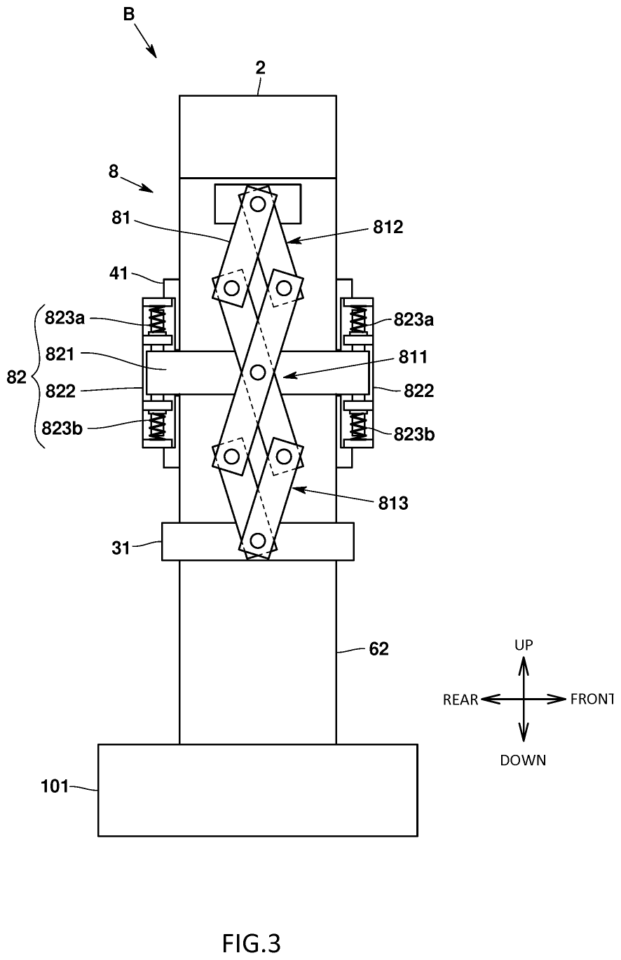

The resin molding module B includes, as illustrated in FIG. 2 and FIG. 3, a stationary platen 2, a movable platen 3 that can be raised and lowered by a clamping mechanism 10, an intermediate plate 4 disposed between the stationary platen 2 and the movable platen 3, the first molding die 5a and the second molding die 5b that each include the upper molding die 51 and the lower molding die 52 that are respectively provided between the stationary platen 2 and the intermediate plate 4 and between the intermediate plate 4 and the movable platen 3, a pair of side wall members 61 and 62 disposed on both lateral sides (in this case, both left and right sides) of the movable platen 3 and the intermediate plate 4, a raising-lowering sliding mechanism 7 that slides the intermediate plate 4 along an up-down direction relative to the pair of side wall members 61 and 62, and a raising-lowering interlocking mechanism 8 that interlocks raising and lowering of the intermediate plate 4 with raising and lowering of the movable platen 3.

On a lower surface of the stationary platen 2, the upper molding die 51 of the first molding die 5a is directly provided or provided via another member. Further, on both left and right sides of the stationary platen 2, the pair of side wall members 61 and 62 is connected. It is to be noted that the pair of side wall members 61 and 62 may be formed integrally with the stationary platen 2. The stationary platen 2 of this embodiment has a substantially-rectangular flat plate shape in plan view.

On an upper surface of the movable platen 3, the lower molding die 52 of the second molding die 5b is directly provided or provided via another member. Further, the movable platen 3 is moved to be raised and lowered by the clamping mechanism 10 provided below the movable platen 3. It is to be noted that the movable platen 3 of this embodiment has a substantially-rectangular flat plate shape in plan view. Further, a fixing member 31 is connected to the movable platen 3, and a lower end portion (lower end link portion 813) of a pantograph mechanism 81 to be described later is fixed to the fixing member 31.

The clamping mechanism 10 of this embodiment is of a linear motion type that uses a ball screw mechanism that converts the rotation of a servomotor or the like into a linear movement to raise and lower the movable platen, but a link type may also be employed. The link type uses a link mechanism such as a toggle link to transmit a power source of a servomotor or the like to the movable platen.

On an upper surface of the intermediate plate 4, the lower molding die 52 of the first molding die 5a is directly provided or provided via another member. On a lower surface of the intermediate plate 4, the upper molding die 51 of the second molding die 5b is directly provided or provided via another member. It is to be noted that the intermediate plate 4 of this embodiment has a substantially-rectangular flat plate shape in plan view.

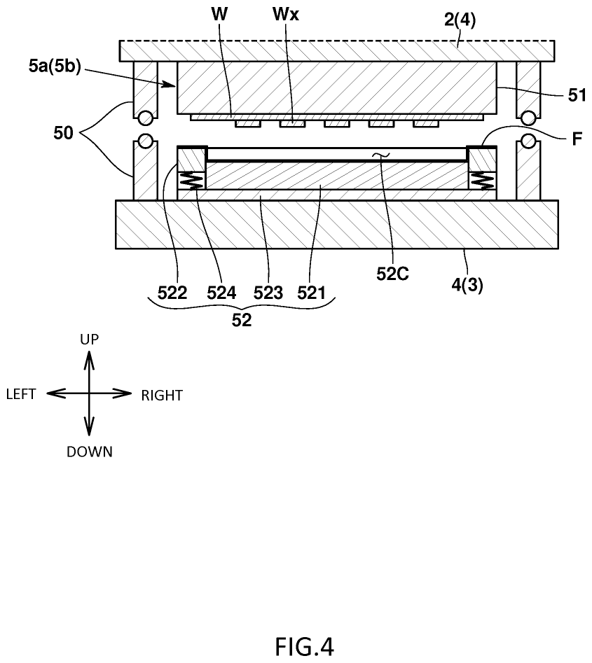

Here, the first molding die 5a and the second molding die 5b are described with reference to FIG. 4.

The upper molding die 51 of each of the molding dies 5a and 5b holds the rear surface of the substrate W by suction. A suction port (not shown) is formed in the lower surface of the upper molding die 51, and a suction flow path (not shown) connected to the suction port is formed in the upper molding die 51. This suction flow path is connected to an external suction device (not shown).

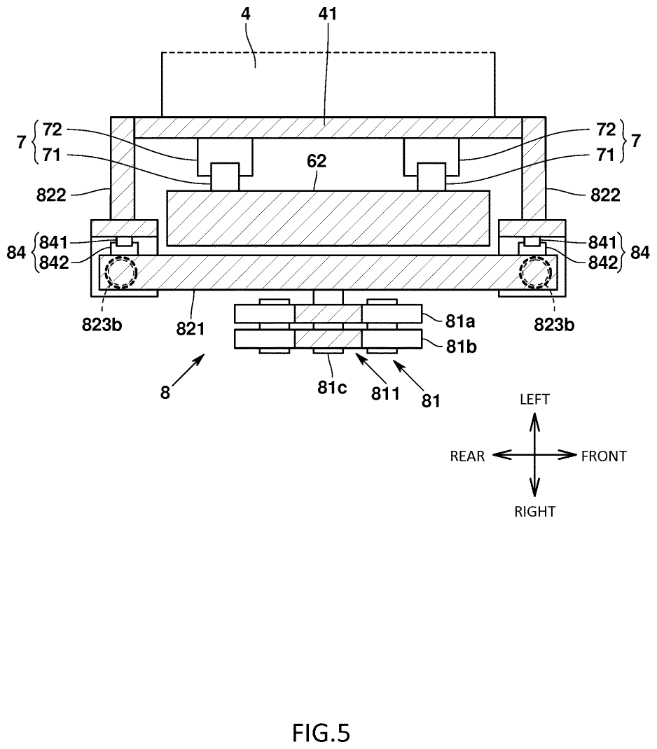

Further, the lower molding die 52 of each of the molding dies 5a and 5b includes the cavity 52C that stores the electronic component Wx fixed to the substrate W and the resin material J. Specifically, the lower molding die 52 includes a bottom surface member 521 forming a bottom surface of the cavity 52C, and a side surface member 522 surrounding the bottom surface member 521. The cavity 52C is formed by an upper surface of the bottom surface member 521 and an inner peripheral surface of the side surface member 522. Further, the side surface member 522 is provided to be movable up and down relative to the bottom surface member 521. Specifically, the side surface member 522 is supported with respect to a base plate 523 of the lower molding die 52 by a plurality of elastic members 524 such as coil springs. Moreover, the lower molding die 52 of this embodiment is covered with the mold release film F in order to improve the releasability of the resin molded product P. Further, in an upper surface of the side surface member 522 (an abutment surface between the side surface member 522 and the substrate W), an air vent (not shown) for discharging air or gas may be provided. In addition, around the upper molding die 51 and the lower molding die 52, a sealing structure 50 (not shown in FIG. 2 and FIG. 5) formed of a side wall portion and a seal member such as an O-ring or the like is provided to perform vacuuming around the molding dies 5a and 5b at the time of resin molding.

As illustrated in FIG. 2 and FIG. 3, the pair of side wall members 61 and 62 fixes the stationary platen 2 to a predetermined height with respect to a base 101, and supports the intermediate plate 4 to be slidable. Here, an upper end portion of each of the side wall members 61 and 62 is connected to the stationary platen 2, and a lower end portion of each of the side wall members 61 and 62 is connected to the base 101. It is to be noted that each of the side wall members 61 and 62 of this embodiment has a vertically-long flat plate shape extending in the up-down direction.

The raising-lowering sliding mechanism 7 linearly moves the intermediate plate 4 relative to the pair of side wall members 61 and 62 along the up-down direction. Specifically, the raising-lowering sliding mechanism 7 includes a linear motion rail 71 extending on a straight line, and a linear motion block 72 that slides on the linear motion rail 71.

In this embodiment, flat-plate-shaped side surface plates 41 are connected on both left and right sides of the intermediate plate 4. The linear motion block 72 is provided on each of the side surface plates 41, and the linear motion rail 71 is provided on an inner surface of each of the side wall members 61 and 62 along the up-down direction (vertical direction).

In detail, as illustrated in FIG. 5, two linear motion rails 71 are provided in parallel in a front-rear direction on the inner surface of each of the side wall members 61 and 62, and two front and rear rows of linear motion blocks 72 are provided on each side surface plate 41 so as to correspond to the two linear motion rails 71. In this case, the row of linear motion blocks 72 provided on each side surface plate 41 is configured of two linear motion blocks 72 (see FIG. 2). That is, a total of four linear motion blocks 72 are provided on the side surface plates 41.

In detail, as illustrated in FIG. 2 and FIG. 5, two linear motion rails 71 are provided on the inner surface of each of the side wall members 61 and 62. Here, the two linear motion rails 71 extend in the up-down direction (vertical direction). Further, the two linear motion rails 71 are disposed side by side in the front-rear direction. Meanwhile, the linear motion blocks 72 are provided on each side surface plate 41. Here, the linear motion blocks 72 are arrayed in two rows arranged in the front-rear direction on each side surface plate 41 so as to correspond to the two linear motion rails 71. In each side surface plate 41, two linear motion blocks 72 are disposed in the up-down direction (vertical direction) in each row. That is, a total of four linear motion blocks 72 are provided on the side surface plates 41. It is to be noted that, for example, in FIG. 2, in a part hidden by a coupling member 822 to be described later, one linear motion block 72 may be added to each side surface plate 41, and a total of six linear motion blocks 72 may be disposed.

As illustrated in FIG. 2, FIG. 3, and FIG. 5 to FIG. 7, the raising-lowering interlocking mechanism 8 interlocks the raising and lowering of the intermediate plate 4 with the raising and lowering of the movable platen 3 to synchronize clamping and unclamping of the first molding die 5a and the second molding die 5b. That is, the raising-lowering interlocking mechanism 8 allows the clamping speed of the first molding die 5a and the clamping speed of the second molding die 5b to be equal to each other, and allows clamping to be performed at the same time.

Specifically, the raising-lowering interlocking mechanism 8 includes the pantograph mechanism 81 that extends and contracts by the raising and lowering of the movable platen 3, and a coupling mechanism 82 that couples the cross-link portion 811 of the pantograph mechanism 81 and the intermediate plate 4.

As illustrated in FIG. 2, the pantograph mechanism 81 is provided on each of left and right outer sides of the pair of side wall members 61 and 62. That is, the movable platen 3 and the intermediate plate 4 are interlocked in raising and lowering by the two left and right pantograph mechanisms 81. It is to be noted that the left and right pantograph mechanisms 81 have the same configuration.

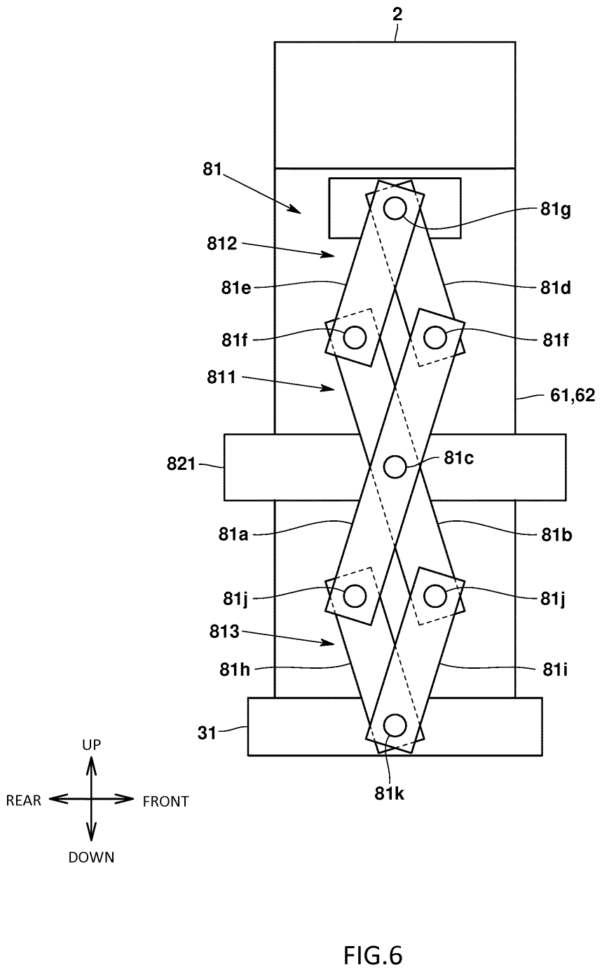

Specifically, each of the pantograph mechanisms 81 is configured of, as illustrated in FIG. 3 and FIG. 6, one cross-link portion 811, an upper end link portion 812, and a lower end link portion 813. The cross-link portion 811 is obtained by crossing a first link 81a and a second link 81b at middle portions thereof and rotatably coupling crossing portions thereof by a rotary shaft 81c. Further, the upper end link portion 812 is obtained by rotatably coupling lower end portions of a third link 81d and a fourth link 81e to upper end portions of the first link 81a and the second link 81b by rotary shafts 81f, and rotatably coupling upper end portions of the third link 81d and the fourth link 81e to each other by a rotary shaft 81g. Moreover, the lower end link portion 813 is obtained by rotatably coupling upper end portions of a fifth link 81h and a sixth link 81i to lower end portions of the first link 81a and the second link 81b by rotary shafts 81j, and rotatably coupling lower end portions of the fifth link 81h and the sixth link 81i to each other by a rotary shaft 81k.

In addition, an upper end portion (the upper end link portion 812) of the pantograph mechanism 81 is fixed to an upper end portion of each of the side wall members 61 and 62, and a lower end portion (the lower end link portion 813) of the pantograph mechanism 81 is fixed to the fixing member 31 that moves together with the movable platen 3. Thus, the lower end portion (the lower end link portion 813) of the pantograph mechanism 81 is connected to the movable platen 3 via the fixing member 31, and moves along with the movement of the movable platen 3. In this embodiment, as illustrated in FIG. 6, the rotary shaft 81c of the cross-link portion 811, the rotary shaft 81g of the upper end link portion 812, and the rotary shaft 81k of the lower end link portion 813 of the pantograph mechanism 81 are disposed in the up-down direction (the vertical direction), and are disposed to be positioned at a center portion in a width direction of each of the side wall members 61 and 62 in side view.

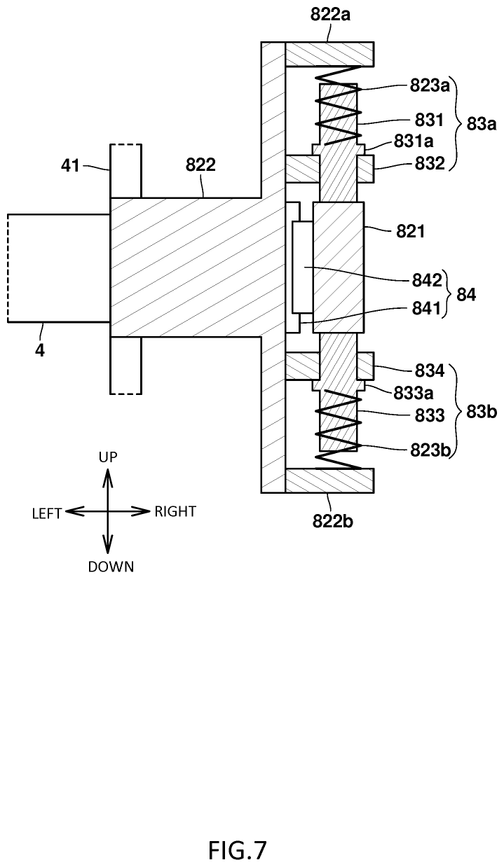

As illustrated in FIG. 2, FIG. 3, FIG. 5, and FIG. 7, the coupling mechanism 82 couples the cross-link portion 811 of the pantograph mechanism 81 and the intermediate plate 4. Specifically, the coupling mechanism 82 includes a connection member 821 connected to the cross-link portion 811, a coupling member 822 that couples the connection member 821 to the intermediate plate 4, and elastic members 823a and 823b interposed between the connection member 821 and the coupling member 822. It is to be noted that the left and right coupling mechanisms 82 have the same configuration.

As illustrated in FIG. 3, FIG. 5, and FIG. 6, the connection member 821 is connected to the cross-link portion 811 without hindering the expansion and contraction of the pantograph mechanism 81. Specifically, the connection member 821 has a rectangular elongated shape, and its middle portion is connected to the rotary shaft 81c of the cross-link portion 811. This connection member 821 is provided to extend in the front-rear direction (the horizontal direction).

The coupling member 822 couples the connection member 821 to the intermediate plate 4, and is connected to, in this embodiment, each of the side surface plates 41 connected to both lateral sides (in this case, both left and right sides) of the intermediate plate 4 (see FIG. 2). This coupling member 822 extends outside of the front and rear of each of the side wall members 61 and 62 (see FIG. 5).

The elastic members 823a and 823b absorb variations in thickness of the substrate W or the like, and are provided to be interposed between the coupling member 822 and the connection member 821. Further, the elastic members 823a and 823b are provided outside of each of the side wall members 61 and 62.

Specifically, as illustrated in FIG. 2, FIG. 3, FIG. 5, and FIG. 7, the elastic members 823a and 823b include the upper elastic member 823a that absorbs upward displacement of the intermediate plate 4 relative to the connection member 821, and the lower elastic member 823b that absorbs downward displacement thereof. Those elastic members 823a and 823b configure, as illustrated in FIG. 7, displacement absorbing mechanisms 83a and 83b provided on the coupling member 822.

The displacement absorbing mechanisms 83a and 83b are respectively provided on the upper side and the lower side of the connection member 821 on the coupling member 822. The upper displacement absorbing mechanism 83a includes an upper contact portion 831 to be in contact with an upper surface of the connection member 821, the upper elastic member 823a that applies a force to (biases) the upper contact portion 831 toward the upper surface of the connection member 821, and an upper support portion 832 that supports the upper contact portion 831 so as to be movable upward. Further, the lower displacement absorbing mechanism 83b includes a lower contact portion 833 to be in contact with a lower surface of the connection member 821, the lower elastic member 823b that applies a force to (biases) the lower contact portion 833 toward the lower surface of the connection member 821, and a lower support portion 834 that supports the lower contact portion 833 so as to be movable downward. The upper support portion 832 and the lower support portion 834 are fixed to the coupling member 822.

Here, in the upper contact portion 831, an upper stopper 831a that protrudes to the surrounding so as to be contactable to an upper surface of the upper support portion 832 to restrict downward movement is formed. In the lower contact portion 833, a lower stopper 833a that protrudes to the surrounding so as to be contactable to a lower surface of the lower support portion 834 to restrict upward movement is formed.

Further, the coupling member 822 includes an upper protruding portion 822a that protrudes to form an opposing surface that is opposed on the upper side of an upper end surface of the upper contact portion 831, and a lower protruding portion 822b that protrudes to form an opposing surface that is opposed on the lower side of a lower end surface of the lower contact portion 833. It is to be noted that, between the upper end surface of the upper contact portion 831 and a lower surface of the upper protruding portion 822a of the coupling member 822 (an opposing surface with the upper end surface of the upper contact portion 831), an interval is provided to the extent that prevents contact due to motions of the displacement absorbing mechanisms 83a and 83b to be described later. Further, between the lower end surface of the lower contact portion 833 and an upper surface of the lower protruding portion 822b of the coupling member 822 (an opposing surface with the lower end surface of the lower contact portion 833), an interval is provided to the extent that prevents contact due to the motions of the displacement absorbing mechanisms 83a and 83b.

Next, basic operations of the displacement absorbing mechanisms 83a and 83b are described.

In an initial state of the displacement absorbing mechanisms 83a and 83b (see FIG. 7), the elastic member 823a has an upper end in contact with the lower surface of the upper protruding portion 822a of the coupling member 822 (an opposing surface with the upper end surface of the upper contact portion 831) and a lower end in contact with an upper surface of the upper stopper 831a of the upper contact portion 831, and is not expanded or contracted. Further, in the initial state of the displacement absorbing mechanisms 83a and 83b, the elastic member 823b has an upper end in contact with a lower surface of the lower stopper 833a of the lower contact portion 833 and a lower end in contact with the upper surface of the lower protruding portion 822b of the coupling member 822 (an opposing surface with the lower end surface of the lower contact portion 833), and is not expanded or contracted.

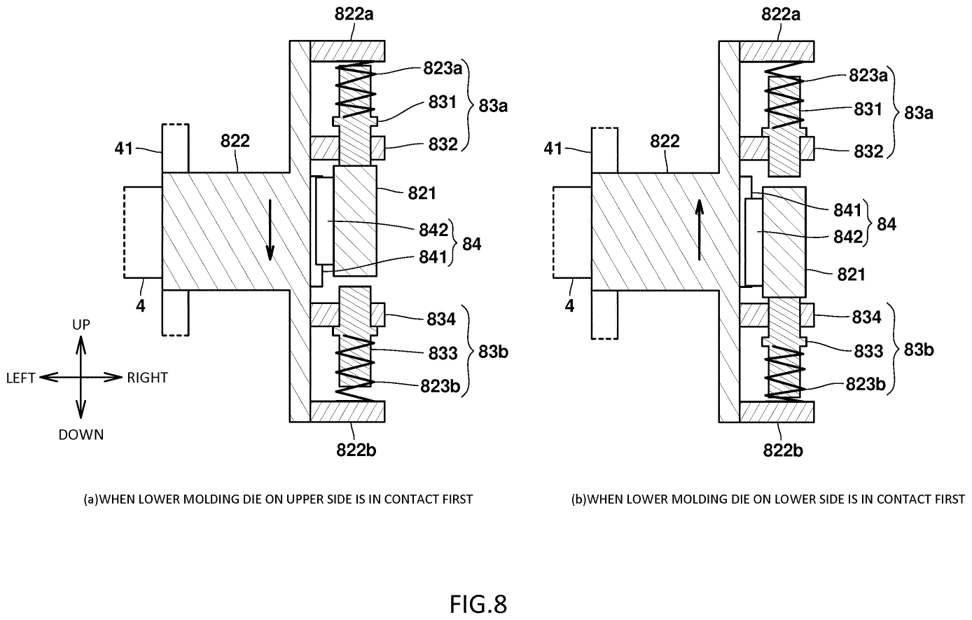

In addition, when the intermediate plate 4 is displaced downward relative to the connection member 821, as illustrated in FIG. 8(a), the coupling member 822 connected to the intermediate plate 4 is displaced downward relative to the connection member 821. Then, with the connection member 821 and the upper contact portion 831 being in a still state, the upper support portion 832 and the upper protruding portion 822a of the coupling member 822 are also displaced downward relatively, and hence the upper elastic member 823a contracts. In other words, the connection member 821 and the upper contact portion 831 move upward relative to the upper protruding portion 822a of the coupling member 822, and hence the upper elastic member 823a contracts. This absorbs the downward displacement of the intermediate plate 4 relative to the connection member 821.

Meanwhile, when the intermediate plate 4 is displaced upward relative to the connection member 821, as illustrated in FIG. 8(b), the coupling member 822 connected to the intermediate plate 4 is displaced upward relative to the connection member 821. Then, with the connection member 821 and the lower contact portion 833 being in a still state, the lower support portion 834 and the lower protruding portion 822b of the coupling member 822 are also displaced upward relatively, and hence the lower elastic member 823b contracts. In other words, the connection member 821 and the lower contact portion 833 move downward relative to the lower protruding portion 822b of the coupling member 822, and hence the lower elastic member 823b contracts. This absorbs the upward displacement of the intermediate plate 4 relative to the connection member 821.

Moreover, as illustrated in FIG. 2, FIG. 5, and FIG. 7, the resin molding apparatus 100 of this embodiment further includes a guide mechanism 84 provided to be interposed between the connection member 821 and the coupling member 822. This guide mechanism 84 guides the movement of the connection member 821 and the coupling member 822 when the connection member 821 and the coupling member 822 move relative to each other.

The guide mechanism 84 guides the movement of the connection member 821 in the up-down direction, and is provided between opposing surfaces between the connection member 821 and the coupling member 822. Specifically, the guide mechanism 84 includes a linear motion rail 841 provided on one of the connection member 821 or the coupling member 822, and a linear motion block 842 provided on the other of the connection member 821 or the coupling member 822. In this embodiment, the linear motion rail 841 is provided on the coupling member 822, and the linear motion block 842 is provided on the connection member 821.

### 1-3. Specific Configuration of Resin Molding Apparatus 100

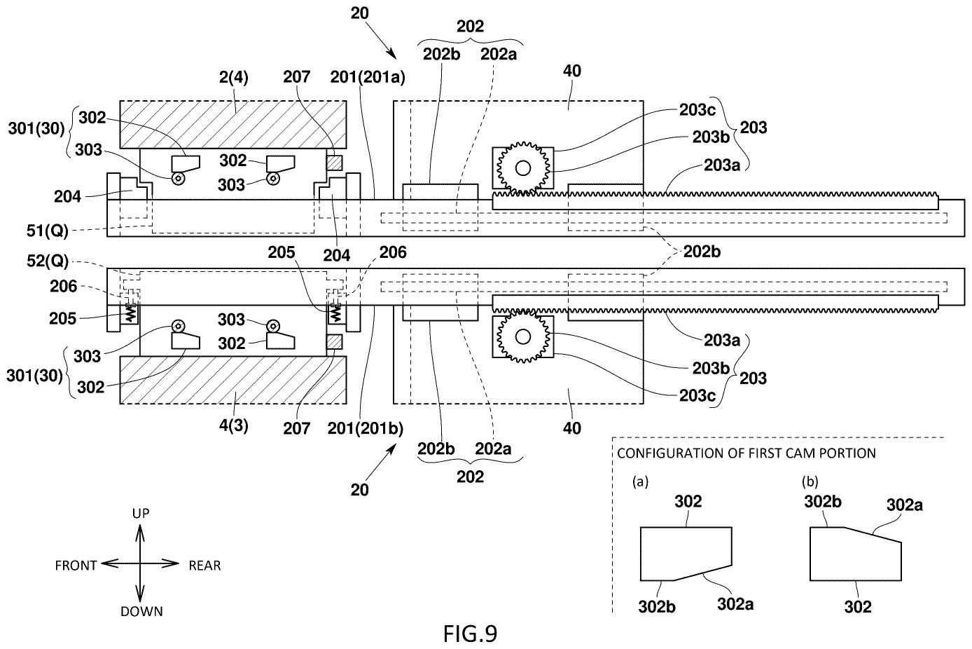

In addition, as illustrated in FIG. 9 to FIG. 13, the resin molding apparatus 100 of this embodiment further includes a molding die sliding mechanism 20 that slides each of the unclamped molding dies 5a and 5b in a sliding direction intersecting with the clamping direction, and an interval changing mechanism 30 that changes an interval between opposing surfaces (surfaces opposed in the clamping direction) of the base member and each of the molding dies 5a and 5b at the time of sliding each of the molding dies 5a and 5b by the molding die sliding mechanism 20. It is to be noted that, in FIG. 1 to FIG. 4 and FIG. 6, illustration of the molding die sliding mechanism 20 and the interval changing mechanism 30 is omitted.

Here, the clamping direction is the up-down direction (the vertical direction), and the sliding direction is the front-rear direction (a direction orthogonal to the up-down direction and the left-right direction). Further, the base member of this embodiment is the stationary platen 2, the movable platen 3, and the intermediate plate 4.

As illustrated in FIG. 9 to FIG. 12, the molding die sliding mechanism 20 is provided to correspond to each of the upper molding die 51 and the lower molding die 52 in the molding dies 5a and 5b. In addition, the molding die sliding mechanism 20 slides the upper molding die 51 and the lower molding die 52 between a clamping position Q at which clamping is performed and a protruding position R positioned outside of the base members 2 to 4 in the sliding direction.

Specifically, the molding die sliding mechanism 20 includes a support frame 201 that supports the upper molding die 51 or the lower molding die 52, a guide portion 202 that guides the movement of the support frame 201 along the sliding direction relative to a corresponding one of the base members 2 to 4, and a drive actuator 203 that moves the support frame 201 along the sliding direction.

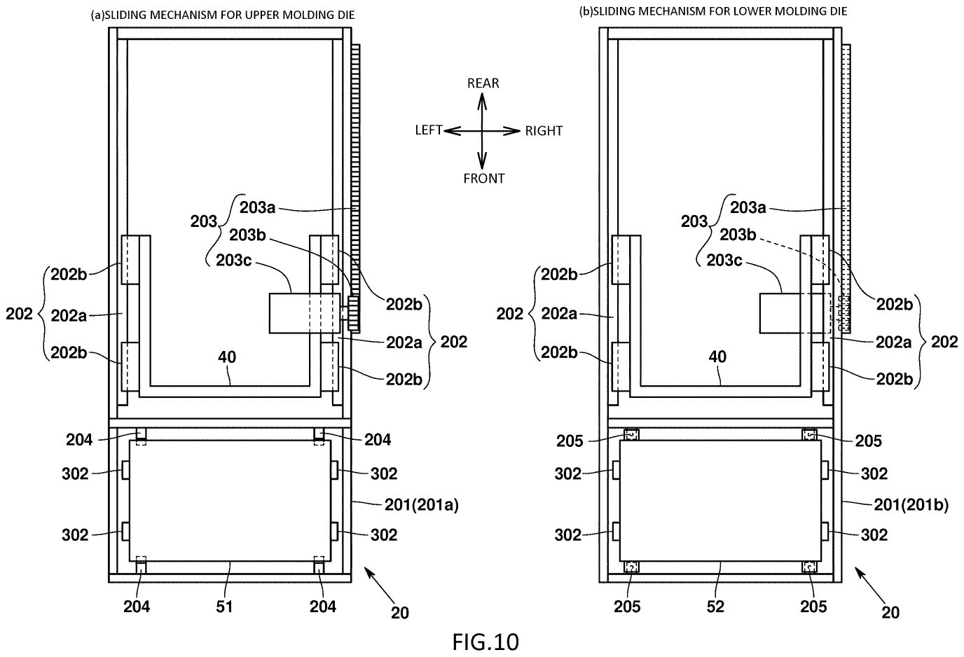

As illustrated in FIG. 9 to FIG. 12, the support frame 201 includes an upper molding die support frame 201a that supports the upper molding die 51, and a lower molding die support frame 201b that supports the lower molding die 52. As illustrated in FIG. 10, each of the support frames 201a and 201b has a rectangular frame shape in plan view, and has a configuration in which the upper molding die 51 or the lower molding die 52 is supported at its opening portion.

In addition, the upper molding die support frame 201a supports the upper molding die 51 so as to be movable in the clamping direction, and includes a stopper portion 204 on which an edge portion of the upper molding die 51 is placed. The stopper portion 204 is provided to correspond to the four corners of the upper molding die 51 (see FIG. 10). Further, the lower molding die support frame 201b supports the lower molding die 52 so as to be movable in the clamping direction, and includes an elastic body 205 that supports an edge portion of the lower molding die 52. The elastic body 205 is provided to correspond to the four corners of the lower molding die 52 (see FIG. 10), and supports the lower molding die 52 via a contact portion 206 that comes into contact with the lower molding die 52. It is to be noted that the contact portion 206 is provided on the lower molding die support frame 201b so as to be movable up and down.

As illustrated in FIG. 9 to FIG. 12, the guide portion 202 is provided to be interposed between a stationary member 40 fixed to a corresponding one of the base members 2 to 4 and the support frame 201.

Specifically, the guide portion 202 is configured by using a linear motion guide, and includes a linear motion rail 202a that is provided on one of the stationary member 40 or the support frame 201 and extends on a straight line along the sliding direction, and a liner motion block 202b that is provided on the other of the stationary member 40 or the support frame 201 and moves and slides on the linear motion rail 202a.

As illustrated in FIG. 9 to FIG. 12, the drive actuator 203 is provided to correspond to each support frame 201, and moves the support frame 201 along the guide portion 202. With this drive actuator 203, the upper molding die 51 and the lower molding die 52 move between the clamping position Q and the protruding position R. The drive actuator 203 of this embodiment includes a rack gear 203a provided on the support frame 201, a pinion gear 203b meshing with the rack gear 203a, and a motor 203c such as a servomotor that rotates the pinion gear 203b. It is to be noted that the drive actuator 203 is not limited to the above-mentioned rack and pinion configuration, and may be one that uses a ball screw mechanism or an air cylinder, for example.

In this embodiment, the upper molding die 51 of the first molding die 5a provided on the lower surface of the stationary platen 2 is configured to slide by the upper molding die support frame 201a via the stationary member 40 fixed to the stationary platen 2. The lower molding die 52 of the first molding die 5a provided on the upper surface of the intermediate plate 4 is configured to slide by the lower molding die support frame 201b via the stationary member 40 fixed to the intermediate plate 4. Further, the upper molding die 51 of the second molding die 5b provided on the lower surface of the intermediate plate 4 is configured to slide by the upper molding die support frame 201a via the stationary member 40 fixed to the intermediate plate 4. That is, the lower molding die support frame 201b for the lower molding die 52 of the first molding die 5a and the upper molding die support frame 201a for the upper molding die 51 of the second molding die 5b are configured to slide via the common stationary member 40. Moreover, the lower molding die 52 of the second molding die 5b provided on the upper surface of the movable platen 3 is configured to slide by the lower molding die Support frame 201b via the stationary member 40 fixed to the movable platen 3.

Further, as illustrated in FIG. 9 and FIG. 11 to FIG. 13, the molding die sliding mechanism 20 includes a positioning portion 207 that comes into contact with side surfaces of the upper molding die 51 and the lower molding die 52 that move to the clamping position Q to position the upper molding die 51 and the lower molding die 52 at the clamping position Q. This positioning portion 207 positions the upper molding die 51 and the lower molding die 52 relative to the base members 2 to 4 in the horizontal direction (the front-rear direction and the left-right direction).

It is to be noted that the molding die sliding mechanism 20 may be configured to position the upper molding die 51 and the lower molding die 52 at the clamping position Q through position control performed by the drive actuator 203 without including the above-mentioned positioning portion 207 or in addition to the above-mentioned positioning portion 207.

As illustrated in FIG. 9 to FIG. 13, the interval changing mechanism 30 is provided to correspond to each of the upper molding die 51 and the lower molding die 52 in the molding dies 5a and 5b, similarly to the molding die sliding mechanism 20. In addition, the interval changing mechanism 30 changes, at the time of sliding the upper molding die 51 and the lower molding die 52 between the clamping position Q and the protruding position R by the molding die sliding mechanism 20, intervals between opposing surfaces of the base members 2 to 4 and the upper and lower molding dies 51 and 52.

The interval changing mechanism 30 provided to correspond to the upper molding die 51 of the first molding die 5a changes an interval between the lower surface of the stationary platen 2 to which the upper molding die 51 is mounted and the upper surface of the upper molding die 51 of the first molding die 5a to be mounted to the stationary platen 2. The interval changing mechanism 30 provided to correspond to the lower molding die 52 of the first molding die 5a changes an interval between the upper surface of the intermediate plate 4 to which the lower molding die 52 is mounted and the lower surface of the lower molding die 52 of the first molding die 5a to be mounted to the intermediate plate 4. The interval changing mechanism 30 provided to correspond to the upper molding die 51 of the second molding die 5b changes an interval between the lower surface of the intermediate plate 4 to which the upper molding die 51 is mounted and the upper surface of the upper molding die 51 of the second molding die 5b to be mounted to the intermediate plate 4. The interval changing mechanism 30 provided to correspond to the lower molding die 52 of the second molding die 5b changes an interval between the upper surface of the movable platen 3 to which the lower molding die 52 is mounted and the lower surface of the lower molding die 52 of the second molding die 5b to be mounted to the movable platen 3.

Specifically, the interval changing mechanism 30 is configured by using the drive actuator 203 of the molding die sliding mechanism 20. Further, the interval changing mechanism 30 also includes a cam mechanism 301 provided to be interposed between the upper molding die 51 or the lower molding die 52 and a corresponding one of the base members 2 to 4. In addition, in this interval changing mechanism 30, along with the movement of the support frame 201 by the drive actuator 203, the cam mechanism 301 changes the interval between the opposing surfaces of the upper molding die 51 or the lower molding die 52 and a corresponding one of the base members 2 to 4.

The cam mechanism 301 of this embodiment includes a first cam portion 302 that is provided on the upper molding die 51 and the lower molding die 52 and has a contact surface, and a second cam portion 303 that is fixed to the base members 2 to 4 and comes into contact with the contact surface of the first cam portion 302.

Here, as illustrated in “CONFIGURATION OF FIRST CAM PORTION” of FIG. 9, the contact surface includes an inclined surface 302a for shortening or widening the interval between the opposing surfaces of the upper molding die 51 or the lower molding die 52 and a corresponding one of the base members 2 to 4, and a flat surface 302b for maintaining the shortened interval. Further, the first cam portion 302 is provided at two locations on each of both sides of the upper molding die 51 and the lower molding die 52, and the second cam portion 303 is provided at two locations on each of both sides of the base members 2 to 4 so as to correspond to the first cam portion 302. It is to be noted that the second cam portion 303 can be configured of a roller member, a rolling element (a bearing), a bush, or the like.

### 1-3-1. Mechanism of Changing Interval Between Upper Molding Die 51 and Base Member 2 or 4

Specifically, the cam mechanism 301 corresponding to the upper molding die support frame 201a is configured to lift the upper molding die 51 placed on the stopper portion 204 of the upper molding die support frame 201a from the stopper portion 204, and the inclined surface 302a of the first cam portion 302 is, as illustrated in “CONFIGURATION OF FIRST CAM PORTION (a) ” of FIG. 9, a downward surface and is a surface having an upward slope from the protruding position R toward the clamping position Q.

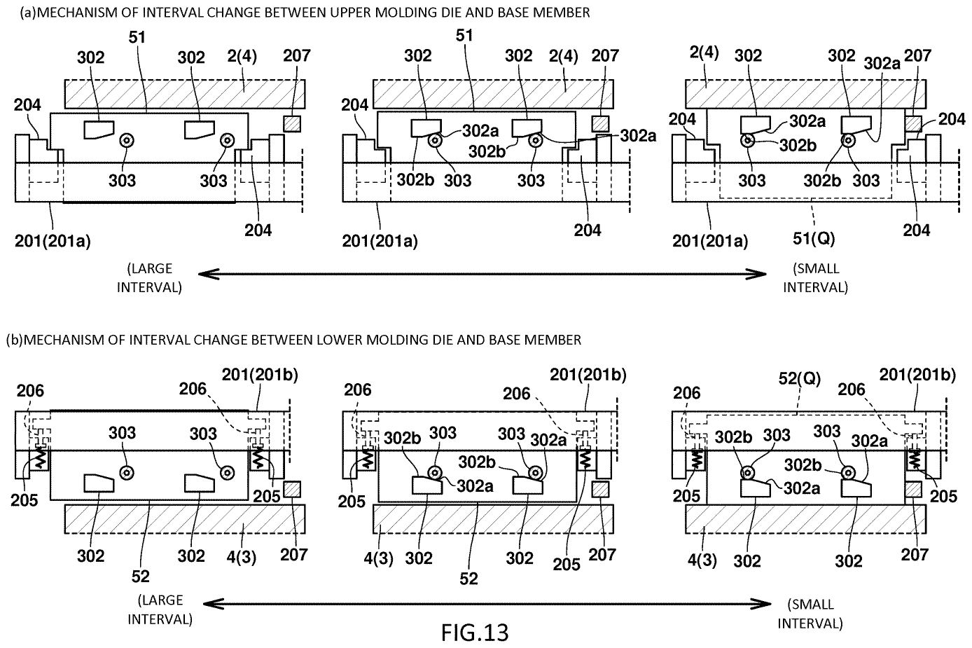

With this configuration, when the upper molding die 51 slides from the protruding position R to the clamping position Q, as illustrated in FIG. 13(a), the inclined surface 302a of the first cam portion 302 comes into contact with and rides up the corresponding second cam portion 303, and thus the upper molding die 51 is lifted from the stopper portion 204, and the upper surface of the upper molding die 51 approaches the lower surface of the base member 2 or 4, with the result that the interval therebetween is reduced. It is to be noted that, at the clamping position Q, the flat surface 302b of the first cam portion 302 is in contact with the second cam portion 303.

Meanwhile, when the upper molding die 51 slides from the clamping position Q to the protruding position R, the first cam portion 302 of the upper molding die 51 separates from the corresponding second cam portion 303. Thus, the upper molding die 51 moves by its own weight to be placed on the stopper portion 204, and the upper surface of the upper molding die 51 separates from the lower surface of the base member 2 or 4, with the result that the interval therebetween is increased.

### 1-3-2. Mechanism of Changing Interval Between Lower Molding Die 52 and Base Member 3 or 4

Specifically, the cam mechanism 301 corresponding to the lower molding die support frame 201b is configured to push the lower molding die 52 supported by the elastic body 205 and the contact portion 206 of the lower molding die support frame 201b to the side of the elastic body 205 (the base members 2 to 4), and the inclined surface 302a of the first cam portion 302 is, as illustrated in “CONFIGURATION OF FIRST CAM PORTION (b) ” of FIG. 9, an upward surface and is a surface having a downward slope from the protruding position R toward the clamping position Q.

With this configuration, when the lower molding die 52 slides from the protruding position R to the clamping position Q, as illustrated in FIG. 13(b), the inclined surface 302a of the first cam portion 302 of the lower molding die 52 comes into contact with the corresponding second cam portion 303, and thus the lower molding die 52 is pushed to the elastic body 205 side, and the lower surface of the lower molding die 52 approaches the upper surface of the base member 3 or 4, with the result that the interval therebetween is reduced. It is to be noted that, at the clamping position Q, the flat surface 302b of the first cam portion 302 is in contact with the second cam portion 303.

Meanwhile, when the lower molding die 52 slides from the clamping position Q to the protruding position R, the first cam portion 302 of the lower molding die 52 separates from the corresponding second cam portion 303. Thus, the lower molding die 52 moves upward by a force applied from the elastic body 205, and the lower surface of the lower molding die 52 separates from the upper surface of the base member 3 or 4, with the result that the interval therebetween is increased.

Here, the cam mechanism 301 of the interval changing mechanism 30 keeps, at the clamping position Q, the opposing surfaces of the upper molding die 51 or the lower molding die 52 and a corresponding one of the base members 2 to 4 in a state of having a slight gap without bringing the opposing surfaces into contact with each other. Then, when the clamping mechanism 10 clamps the molding dies 5a and 5b, the opposing surfaces of the upper molding die 51 or the lower molding die 52 and a corresponding one of the base members 2 to 4 come into contact with each other. At this time, the upper molding die 51 or the lower molding die 52 comes into close contact with the corresponding one of the base members 2 to 4, and thus the first cam portion 302 and the second cam portion 303 provided on the upper molding die 51 or the lower molding die 52 are separated, and the cam mechanism 301 is not damaged by clamping. It is to be noted that the cam mechanism 301 may be configured to bring the opposing surfaces of the upper molding die 51 or the lower molding die 52 and a corresponding one of the base members 2 to 4 into contact with each other at the clamping position Q.

### 1-4. Specific Configurations of Conveying Mechanisms 13 and 18

Next, specific configurations of the substrate conveying mechanism 13 and the resin material conveying mechanism 18 of this embodiment are described.

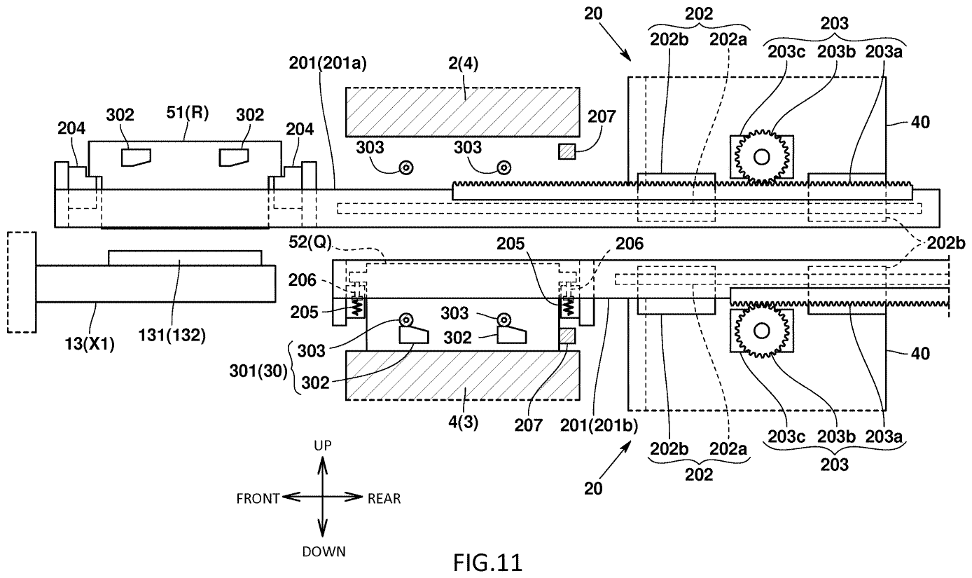

The substrate conveying mechanism 13 conveys the substrate W and the resin molded product P that are conveying targets to the upper molding die 51 present at the protruding position R. As illustrated in FIG. 11, the substrate conveying mechanism 13 moves to a conveying position X1 at which the substrate W and the resin molded product P are conveyed to the upper molding die 51 present at the protruding position R. Here, the conveying position X1 is a position at which the substrate conveying mechanism 13 is positioned below the upper molding die 51 present at the protruding position R to convey, that is, deliver the substrate W and the resin molded product P. It is to be noted that, when the substrate conveying mechanism 13 conveys the substrate W and the resin molded product P to the upper molding die 51, the lower molding die 52 is at the clamping position Q so as not to hinder the conveyance of the substrate W and the resin molded product P to the upper molding die 51. Further, the substrate conveying mechanism 13 is configured to move in a left-right direction between the conveying position X1 and a retracted position (not shown). Here, the conveying position X1 can also be expressed as a delivery position at which the substrate W that is the conveying target is delivered between the upper molding die 51 that is the molding die present at the protruding position R and the substrate conveying mechanism 13.

Specifically, as illustrated in FIG. 1, the substrate conveying mechanism 13 includes a substrate supplying unit 131 that supplies the substrate W to the upper molding die 51 present at the protruding position R, and a substrate receiving unit 132 that receives the resin molded product P from the upper molding die 51 present at the protruding position R. The substrate supplying unit 131 and the substrate receiving unit 132 are provided to correspond to each upper molding die 51, and are provided side by side in the left-right direction.

In addition, the substrate conveying mechanism 13 moves left and right at the conveying position X1 to successively perform a receiving operation of the substrate receiving unit 132 and a supplying operation of the substrate supplying unit 131. When the receiving operation of the substrate receiving unit 132 is performed, the substrate receiving unit 132 is positioned below the upper molding die 51 present at the protruding position R, and, when the supplying operation of the substrate supplying unit 131 is performed, the substrate supplying unit 131 is positioned below the upper molding die 51 present at the protruding position R.

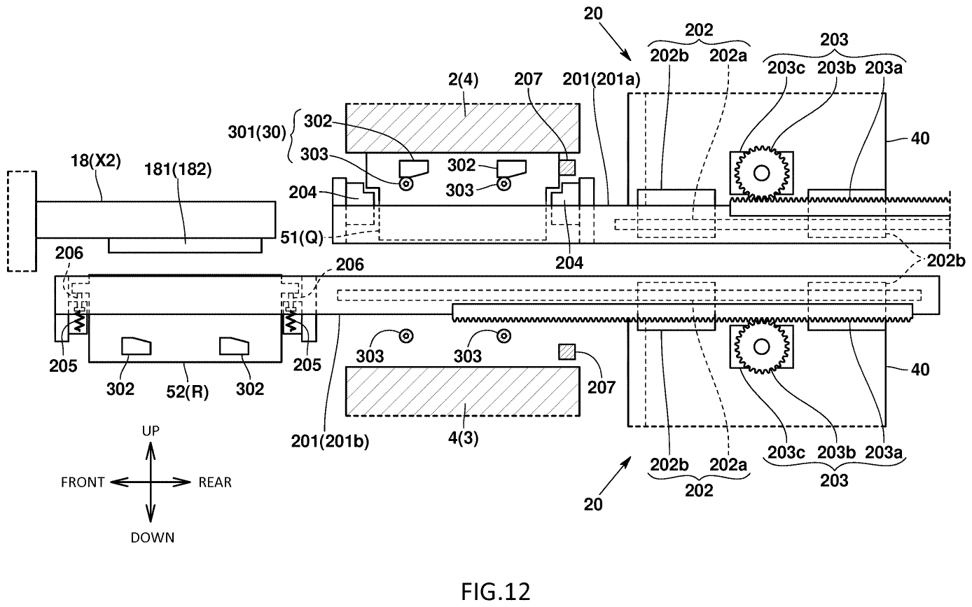

The resin material conveying mechanism 18 conveys the resin material J and the mold release film F that are conveying targets to the lower molding die 52 present at the protruding position R. As illustrated in FIG. 12, the resin material conveying mechanism 18 moves to a conveying position X2 at which the resin material J and the mold release film F are conveyed to the lower molding die 52 present at the protruding position R. Here, the conveying position X2 is a position at which the resin material conveying mechanism 18 is positioned above the lower molding die 52 present at the protruding position R to convey, that is, deliver the resin material J and the mold release film F. It is to be noted that, when the resin material conveying mechanism 18 conveys the resin material J and the mold release film F to the lower molding die 52, the upper molding die 51 is at the clamping position Q so as not to hinder the conveyance of the resin material J and the mold release film F to the lower molding die 52. Further, the resin material conveying mechanism 18 is configured to move in the left-right direction between the conveying position X2 and a retracted position (not shown). Here, the conveying position X2 can also be expressed as a delivery position at which the resin material J that is the conveying target is delivered between the lower molding die 52 that is the molding die present at the protruding position R and the resin material conveying mechanism 18.

Specifically, as illustrated in FIG. 1, the resin material conveying mechanism 18 includes a resin material supplying unit 181 that supplies the resin material J and a mold release film F before use to the lower molding die 52 present at the protruding position R, and a film collecting unit 182 that collects the used release film F from the lower molding die 52 present at the protruding position R. The resin material supplying unit 181 and the film collecting unit 182 are provided to correspond to each lower molding die 52, and are provided side by side in the left-right direction.

In addition, the resin material conveying mechanism 18 moves left and right at the conveying position X2 to successively perform a collecting operation of the film collecting unit 182 and a supplying operation of the resin material supplying unit 181. When the collecting operation of the film collecting unit 182 is performed, the film collecting unit 182 is positioned above the lower molding die 52 present at the protruding position R, and, when the supplying operation of the resin material supplying unit 181 is performed, the resin material supplying unit 181 is positioned above the lower molding die 52 present at the protruding position R.

### 1-5. Example of Operation of Resin Molding Apparatus 100

Next, an example of the operation of the resin molding apparatus 100 is described with reference to FIG. 1, FIG. 2, FIG. 4, and FIG. 8. The operation described below is performed by, for example, a control unit COM provided in the substrate supplying and storing module A controlling each unit of the resin molding apparatus 100. It is to be noted that the control unit COM is a dedicated or general-purpose computer including a CPU, an internal memory, an input/output interface, an AD converter, and the like.

### 1-5-1. Overall Operation

First, with the molding dies 5a and 5b being set to an unclamped state by the raising-lowering interlocking mechanism 8 (see FIG. 2), the substrate supplying and storing module A illustrated in FIG. 1 conveys the substrate W to the upper molding die 51 of each of the molding dies 5a and 5b and causes the upper molding die 51 to hold the substrate W. Further, the resin material supplying module C stores the mold release film F and the resin material J into the cavity 52C of the lower molding die 52 of each of the molding dies 5a and 5b. In this state, the substrate W that is the molding target and the mold release film F, and the resin material J are supplied to each of the molding dies 5a and 5b.

Next, the movable platen 3 is raised by the clamping mechanism 10. Along with the rising of the movable platen 3, the pantograph mechanism 81 contracts, and the intermediate plate 4 connected to the rotary shaft 81c of the cross-link portion 811 of the pantograph mechanism 81 rises. Here, along with the rising of the movable platen 3, the surroundings of the molding dies 5a and 5b are sealed by the sealing structure 50 illustrated in FIG. 5, and vacuuming is performed around the molding dies 5a and 5b by a vacuum pump (not shown).

Then, the upper surface of the lower molding die 52 of each of the molding dies 5a and 5b (specifically, the upper surface of the side surface member 522, or the mold release film F when there is the mold release film F) comes into contact with the substrate W suctioned and held by the upper molding die 51. At this time, when the lower molding dies 52 of the first molding die 5a and the second molding die 5b come into contact with the upper molding dies 51 at different timings, the upper elastic member 823a or the lower elastic member 823b is deformed earlier than the elastic member 524 of the lower molding die 52. That is, the spring constant of the upper elastic member 823a and the lower elastic member 823b is smaller than the spring constant of the elastic member 524 of the lower molding die 52.

For example, when the lower molding die 52 on the intermediate plate 4 (the lower molding die 52 of the first molding die 5a) comes into contact with the substrate W suctioned and held by the corresponding upper molding die 51 earlier than the lower molding die 52 on the movable platen 3 (the lower molding die 52 of the second molding die 5b), the intermediate plate 4 is displaced downward relative to the connection member 821 and the upper elastic member 823a contracts (see FIG. 8(a)).

Meanwhile, when the lower molding die 52 on the movable platen 3 (the lower molding die 52 of the second molding die 5b) comes into contact with the substrate W suctioned and held by the corresponding upper molding die 51 earlier than the lower molding die 52 on the intermediate plate 4 (the lower molding die 52 of the first molding die 5a), the intermediate plate 4 is displaced upward relative to the connection member 821 and the lower elastic member 823b contracts (see FIG. 8(b)).

With those, the clamping operation is performed while eliminating the difference in timing at which the lower molding die 52 comes into contact with the upper molding die 51 in the first molding die 5a and the second molding die 5b. Further, the upper elastic member 823a and the lower elastic member 823b absorb not only variations in thickness of the substrate W, but also variations in amount of the resin material J stored in the cavity 52C, variations in volume of the electronic component Wx fixed to the substrate W, and the like.

After that, the clamping mechanism 10 further raises the movable platen 3. Thus, the clamping of the first molding die 5a and the second molding die 5b is completed, and this state is maintained for a predetermined time (for example, a curing time of the resin material J) to complete the resin molding. In this way, the molding dies 5a and 5b are clamped by using the raising-lowering interlocking mechanism 8, and resin molding is performed. After that, when the clamping mechanism 10 lowers the movable platen 3, the molding dies 5a and 5b are unclamped. Then, the substrate supplying and storing module A stores the resin molded product P to the substrate storing unit 12 (see FIG. 1). In this way, the molding dies 5a and 5b are unclamped by using the raising-lowering interlocking mechanism 8, and the substrate W (the resin molded product P) that is the molding target subjected to resin molding is removed from each of the molding dies 5a and 5b and stored in the substrate storing unit 12. Thus, the resin molded product P is manufactured.

### 1-5-2. Details of Conveying Process Before (After) Resin Molding Process

Next, details of a conveying process before (after) the resin molding process is described with reference to FIG. 11 to FIG. 14 and others.

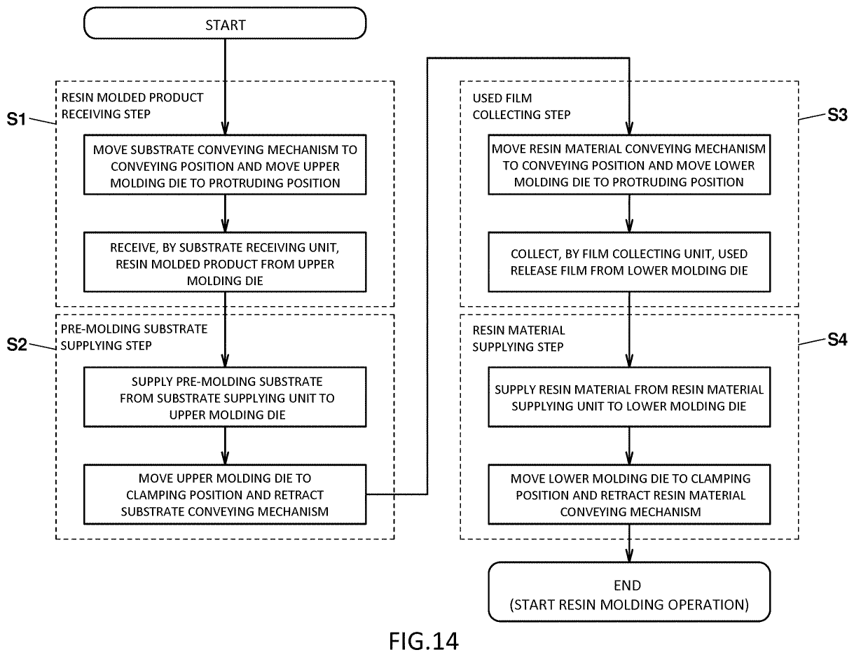

### (Resin Molded Product Receiving Step: S1 (see FIG. 14))

With the molding dies 5a and 5b being unclamped (see FIG. 2), as illustrated in FIG. 11, the molding die sliding mechanism 20 collectively moves the upper molding dies 51 of the molding dies 5a and 5b from the clamping position Q to the protruding position R (a first upper molding die sliding step). Further, the substrate conveying mechanism 13 moves to the conveying position X1. It is to be noted that, in the first upper molding die sliding step, as illustrated in FIG. 13(a), the interval changing mechanism 30 increases the interval between the opposing surfaces of the base member 2 or 4 and the upper molding die 51. Then, the substrate receiving unit 132 of the substrate conveying mechanism 13 receives the resin molded products P collectively from the upper molding dies 51 present at the protruding position R.

### (Pre-Molding Substrate Supplying Step: S2 (see FIG. 14))

Next, the substrate supplying unit 131 of the substrate conveying mechanism 13 collectively supplies the pre-molding substrates W to the upper molding dies 51 present at the protruding position R and causes the upper molding die 51 to hold the pre-molding substrates W (a substrate conveying step). After that, the molding die sliding mechanism 20 collectively moves the upper molding dies 51 holding the pre-molding substrates W from the protruding position R to the clamping position Q (a second upper molding die sliding step). Further, the substrate conveying mechanism 13 moves to the retracted position. It is to be noted that, in the second upper molding die sliding step, as illustrated in FIG. 13(a), the interval changing mechanism 30 decreases the interval between the opposing surfaces of the base member 2 or 4 and the upper molding die 51.

### (Used Film Collecting Step: S3 (see FIG. 14))

As illustrated in FIG. 12, the molding die sliding mechanism 20 collectively moves the lower molding dies 52 of the molding dies 5a and 5b from the clamping position Q to the protruding position R (a first lower molding die sliding step). Further, the resin material conveying mechanism 18 is moved to the conveying position X2. It is to be noted that, in the first lower molding die sliding step, as illustrated in FIG. 13(b), the interval changing mechanism 30 increases the interval between the opposing surfaces of the base member 3 or 4 and the lower molding die 52. Then, the film collecting unit 182 of the resin material conveying mechanism 18 collectively collects the used release films F from the lower molding dies 52 present at the protruding position R.

### (Resin Material Supplying Step: S4 (see FIG. 14))

Next, the resin material supplying unit 181 of the resin material conveying mechanism 18 supplies mold release films F before use and resin materials J to the lower molding dies 52 (a resin material conveying step). After that, the molding die sliding mechanism 20 collectively moves the lower molding dies 52 to which the mold release films F and the resin materials J have been supplied from the protruding position R to the clamping position Q (a second lower molding die sliding step). Further, the resin material conveying mechanism 18 is moved to the retracted position. It is to be noted that, in the second lower molding die sliding step, as illustrated in FIG. 13(b), the interval changing mechanism 30 decreases the interval between the opposing surfaces of the base member 3 or 4 and the lower molding die 52.

After that, the next resin molding process is performed. Further, the resin molded product P received by the substrate conveying mechanism 13 is stored in the substrate storing unit 12 (see FIG. 1). Moreover, the used release film F collected by the resin material conveying mechanism 18 is disposed of in a disposal box (not shown).

### 1-5-3. Sliding Operation of Upper Molding Die 51 and Moving Operation of Substrate Conveying Mechanism 13

In this embodiment, a first moving operation of the substrate conveying mechanism 13 to the conveying position X1 at which the substrate W is delivered, that is, conveyed to the upper molding die 51 present at the protruding position R is started earlier than a first sliding operation to the protruding position R of the upper molding die 51 performed by the molding die sliding mechanism 20, or the first sliding operation is performed so as to overlap at least a part of a period of the first moving operation.

Performing the first sliding operation so as to overlap at least a part of the period of the first moving operation means that the first moving operation and the first sliding operation are executed simultaneously for at least a part of the period, or that there is a period during which the first moving operation and the first sliding operation are executed simultaneously.

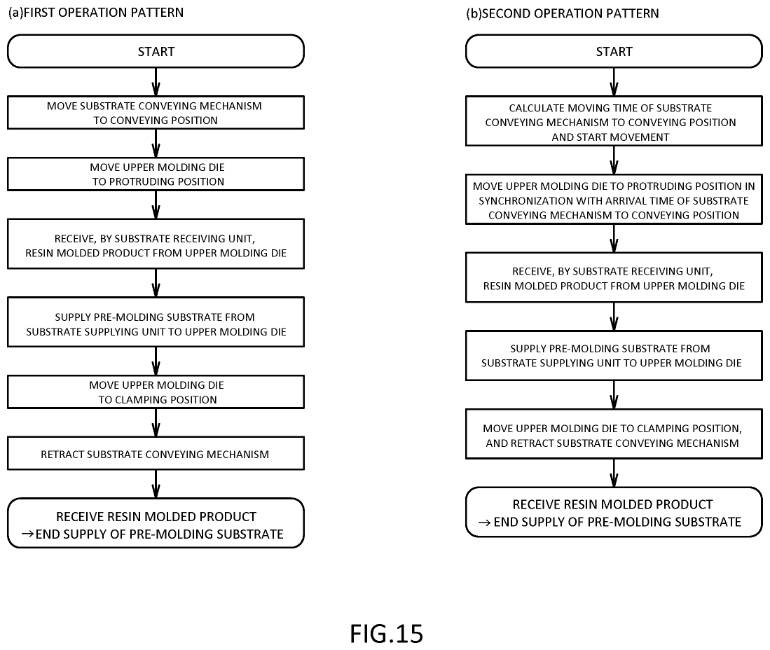

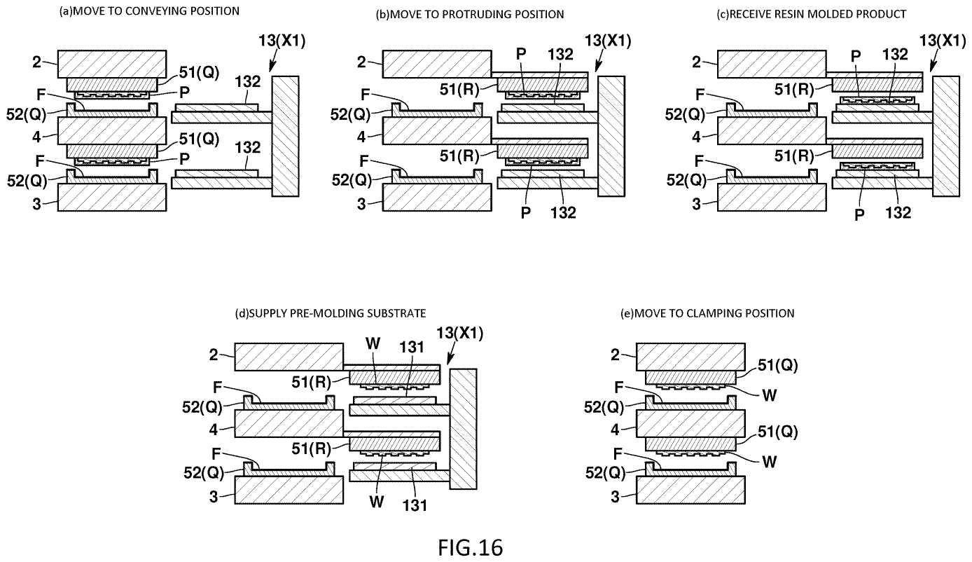

Specifically, as illustrated in (a) FIRST OPERATION PATTERN of FIG. 15 and FIG. 16, it is conceivable to perform the first sliding operation after the first moving operation is completed. That is, after the substrate conveying mechanism 13 moves to the conveying position X1 (see FIG. 16(a)), the molding die sliding mechanism 20 starts sliding of the upper molding die 51 and moves the upper molding die 51 to the protruding position R (see FIG. 16(b)). Then, the substrate receiving unit 132 of the substrate conveying mechanism 13 receives the resin molded product P from the upper molding die 51 present at the protruding position R (see FIG. 16(c)). Further, the substrate supplying unit 131 of the substrate conveying mechanism 13 supplies the pre-molding substrate W to the upper molding die 51 present at the protruding position R (see FIG. 16(d)). After the pre-molding substrate W is supplied from the substrate conveying mechanism 13 to the upper molding die 51, the molding die sliding mechanism 20 starts sliding of the upper molding die 51 and moves the upper molding die 51 to the clamping position Q (see FIG. 16(e)). After the upper molding die 51 moves to the clamping position Q, the substrate conveying mechanism 13 is retracted from the conveying position X1 to the retracted position. As described above, with the substrate conveying mechanism 13 being moved to the conveying position X1 in advance, the time in which the upper molding die 51 stays at the protruding position R can be reduced, the temperature of the upper molding die 51 can be prevented from being reduced, and contamination of the upper molding die 51 or the resin molded product P (for example, adhesion or mixture of foreign matters or the like) can be prevented.

Further, it is conceivable to complete the first moving operation and the first sliding operation simultaneously or within a predetermined time. In this case, as illustrated in (b) SECOND OPERATION PATTERN of FIG. 15, the time required for the substrate conveying mechanism 13 to move from the retracted position to the conveying position X1 is calculated. This moving time may be calculated in advance and stored in a memory. It is to be noted that the moving time required for the upper molding die 51 to move from the clamping position Q to the protruding position R is calculated in advance. Then, the sliding operation of the upper molding die 51 is performed in synchronization with the time at which the substrate conveying mechanism 13 reaches the conveying position X1. In this way, the upper molding die 51 reaches the protruding position R at the same time at which the substrate conveying mechanism 13 reaches the conveying position X1. Further, after the substrate W is supplied from the substrate conveying mechanism 13, the sliding operation of the upper molding die 51 from the protruding position R to the clamping position Q and the operation of the substrate conveying mechanism 13 from the conveying position X1 to the retracted position are started simultaneously or at a predetermined timing. As described above, when the first moving operation of the substrate conveying mechanism 13 and the first sliding operation of the upper molding die 51 are completed simultaneously or within a predetermined time, the takt time of the resin molding apparatus 100 can be reduced, and the productivity of the resin molding apparatus 100 can be improved.

In addition, as a mode for performing the first sliding operation so as to overlap at least a part of the period of the first moving operation, the sliding movement of the upper molding die 51 may be started before the substrate conveying mechanism 13 reaches the conveying position X1, and the substrate conveying mechanism 13 may reach the conveying position X1 before the upper molding die 51 reaches the protruding position R. That is, the substrate conveying mechanism 13 may reach the conveying position X1 while the upper molding die 51 is moved from the clamping position Q to the protruding position R. Even with this configuration, the time in which the upper molding die 51 stays at the protruding position R can be reduced, the temperature of the upper molding die 51 can be prevented from being reduced, and contamination of the upper molding die 51 or the resin molded product P (for example, adhesion or mixture of foreign matters or the like) can be prevented.

Further, the sliding movement of the upper molding die 51 may be started before the substrate conveying mechanism 13 reaches the conveying position X1, and the substrate conveying mechanism 13 may reach the conveying position X1 after the upper molding die 51 reaches the protruding position R.

### 1-5-4. Sliding Operation of Lower Molding Die 52 and Moving Operation of Resin Material Conveying Mechanism 18

A second moving operation of the resin material conveying mechanism 18 to the conveying position X2 at which the mold release film F and the resin material J are delivered, that is, conveyed to the lower molding die 52 present at the protruding position R is started earlier than a second sliding operation to the protruding position R of the lower molding die 52 performed by the molding die sliding mechanism 20, or the second sliding operation is performed so as to overlap at least a part of a period of the second moving operation.

Performing the second sliding operation so as to overlap at least a part of the period of the second moving operation means that the second moving operation and the second sliding operation are executed simultaneously for at least a part of the period, or that there is a period during which the second moving operation and the second sliding operation are executed simultaneously.

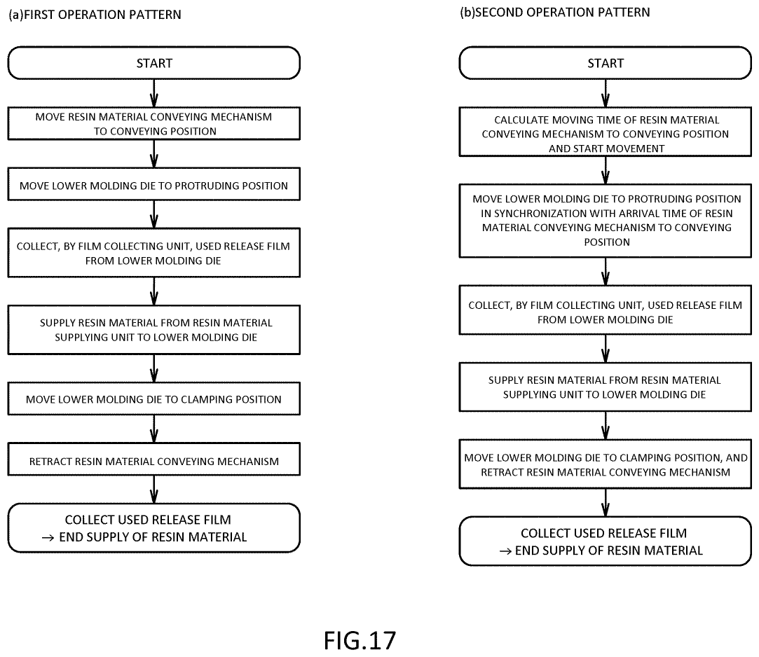

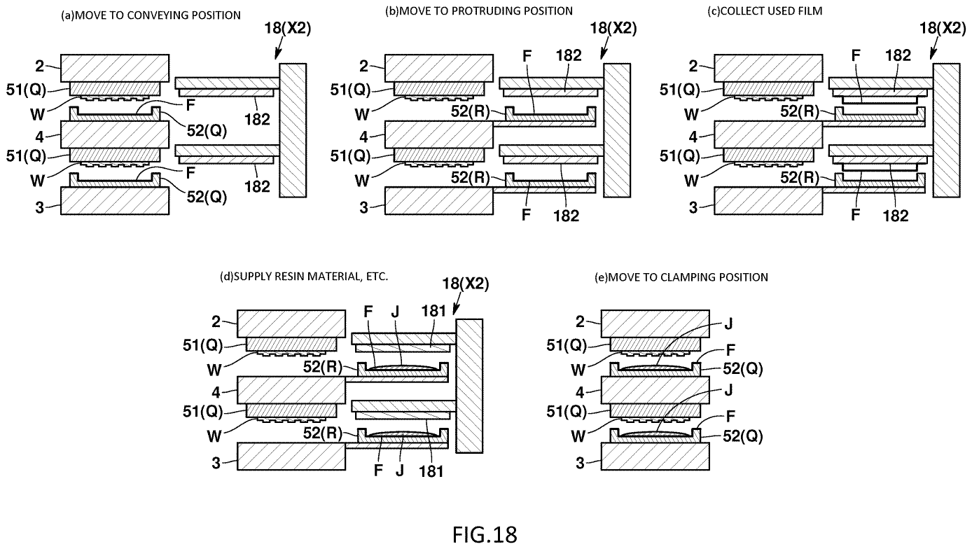

Specifically, as illustrated in (a) FIRST OPERATION PATTERN of FIG. 17 and FIG. 18, it is conceivable to perform the second sliding operation after the second moving operation is completed. That is, after the resin material conveying mechanism 18 moves to the conveying position X2 (see FIG. 18(a)), the molding die sliding mechanism 20 starts sliding of the lower molding die 52 and moves the lower molding die 52 to the protruding position R (see FIG. 18(b)). Further, the film collecting unit 182 of the resin material conveying mechanism 18 collects the used release film F from the lower molding die 52 present at the protruding position R (see FIG. 18(c)). Further, the resin material supplying unit 181 of the resin material conveying mechanism 18 supplies the mold release film F before use and the resin material J to the lower molding die 52 present at the protruding position R (see FIG. 18(d)). After the mold release film F before use and the resin material J are supplied from the resin material conveying mechanism 18 to the lower molding die 52, the molding die sliding mechanism 20 starts sliding of the lower molding die 52 and moves the lower molding die 52 to the clamping position Q (see FIG. 18(e)). After the lower molding die 52 moves to the clamping position Q, the resin material conveying mechanism 18 is retracted from the conveying position X2 to the retracted position. As described above, with the resin material conveying mechanism 18 being moved to the conveying position X2 in advance, the time in which the lower molding die 52 stays at the protruding position R can be reduced, the temperature of the lower molding die 52 can be prevented from being reduced, and contamination of the lower molding die 52 (for example, adhesion or mixture of foreign matters or the like) can be prevented.

Further, it is conceivable to complete the second moving operation and the second sliding operation simultaneously or within a predetermined time. In this case, as illustrated in (b) SECOND OPERATION PATTERN of FIG. 17, the time required for the resin material conveying mechanism 18 to move from the retracted position to the conveying position X2 is calculated. This moving time may be calculated in advance and stored in a memory. It is to be noted that the moving time required for the lower molding die 52 to move from the clamping position Q to the protruding position R is calculated in advance. Then, the sliding operation of the lower molding die 52 is performed in synchronization with the time at which the resin material conveying mechanism 18 reaches the conveying position X2. In this way, the lower molding die 52 reaches the protruding position R at the same time at which the resin material conveying mechanism 18 reaches the conveying position X2. Further, after the mold release film F and the resin material J are supplied from the resin material conveying mechanism 18, the sliding operation of the lower molding die 52 from the protruding position R to the clamping position and the operation of the resin material conveying mechanism 18 from the conveying position X2 to the retracted position are started simultaneously or at a predetermined timing. As described above, when the second moving operation of the resin material conveying mechanism 18 and the second sliding operation of the lower molding die 52 are completed simultaneously or within a predetermined time, the takt time of the resin molding apparatus 100 can be reduced, and the productivity of the resin molding apparatus 100 can be improved.

In addition, as a mode for performing the second sliding operation so as to overlap at least a part of the period of the second moving operation, the sliding movement of the lower molding die 52 may be started before the resin material conveying mechanism 18 reaches the conveying position X2, and the resin material conveying mechanism 18 may reach the conveying position X2 before the lower molding die 52 reaches the protruding position R. That is, the resin material conveying mechanism 18 may reach the conveying position X2 while the lower molding die 52 is moved from the clamping position Q to the protruding position R. Even with this configuration, the time in which the lower molding die 52 stays at the protruding position R can be reduced, the temperature of the lower molding die 52 can be prevented from being reduced, and contamination of the lower molding die 52 (for example, adhesion or mixture of foreign matters or the like) can be prevented.

Further, the sliding movement of the lower molding die 52 may be started before the resin material conveying mechanism 18 reaches the conveying position X2, and the resin material conveying mechanism 18 may reach the conveying position X2 after the lower molding die 52 reaches the protruding position R.

### 1-6. Effect of First Embodiment

With the resin molding apparatus 100 of this embodiment, the first moving operation of the substrate conveying mechanism 13 to the conveying position X1 at which the pre-molding substrate W and the resin molded product P are conveyed to the upper molding die 51 present at the protruding position R is started earlier than the first sliding operation to the protruding position R performed by the molding die sliding mechanism 20, or the first sliding operation is performed so as to overlap at least a part of a period of the first moving operation. Accordingly, a time in which the upper molding die 51 stays at the protruding position R can be reduced. As a result, it is possible to prevent the temperature of the upper molding die 51 present at the protruding position R from being reduced, and to easily maintain the temperature of the upper molding die 51. Further, it is possible to reduce contamination of the upper molding die 51, or reduce the takt time. Thus, it is possible to manufacture the resin molded product P while satisfying a condition such as maintaining the temperature of the upper molding die 51, reducing the contamination of the upper molding die 51, or reducing the takt time.

Further, the second moving operation of the resin material conveying mechanism 18 to the conveying position X2 at which the mold release film F and the resin material J are conveyed to the lower molding die 52 present at the protruding position R is started earlier than the second sliding operation to the protruding position R performed by the molding die sliding mechanism 20, or the second sliding operation is performed so as to overlap at least a part of a period of the second moving operation. Accordingly, a time in which the lower molding die 52 stays at the protruding position R can be reduced. As a result, it is possible to prevent the temperature of the lower molding die 52 present at the protruding position R from being reduced, and to easily maintain the temperature of the lower molding die 52. Further, it is possible to reduce contamination of the lower molding die 52, or reduce the takt time. Thus, it is possible to manufacture the resin molded product P while satisfying a condition such as maintaining the temperature of the lower molding die 52, reducing the contamination of the lower molding die 52, or reducing the takt time.

Moreover, at the time of sliding the molding dies 5a and 5b by the molding die sliding mechanism 20 between the clamping position Q and the protruding position R, the intervals between the opposing surfaces of the base members 2 to 4 and the molding dies 5a and 5b are changed, and hence the opposing surfaces of the base members 2 to 4 and the molding dies 5a and 5b can be separated at the time of sliding. As a result, wearing caused by sliding of the molding dies 5a and 5b can be reduced. Further, with the molding dies 5a and 5b being moved to the protruding position R, the conveying targets (the pre-molding substrate W, the resin molded product P, the mold release film F, and the resin material J) can be conveyed to the molding dies 5a and 5b at the protruding position R. As a result, it is not required to increase the interval between the molding dies 5a and 5b at the time of unclamping, and the height of the resin molding apparatus 100 can be reduced.

The coupling mechanism 82 that couples the cross-link portion 811 of the pantograph mechanism 81 and the intermediate plate 4 includes the connection member 821 connected to the cross-link portion 811, the coupling member 822 that couples the connection member 821 to the intermediate plate 4, and the elastic members 823a and 823b interposed between the connection member 821 and the coupling member 822. Accordingly, it is possible to absorb variations in thickness of the substrate W and the like in each of the molding dies 5a and 5b.

For example, even when the thickness of the pre-molding substrate W held by the upper molding die 51 of the first molding die 5a and the thickness of the pre-molding substrate W held by the upper molding die 51 of the second molding die 5b vary, the elastic members 823a and 823b are elastically deformed, and thus clamping can be performed while the variations in thickness of the pre-molding substrate W and the like are absorbed. As a result, in the resin molding apparatus 100 that clamps the plurality of molding dies 5a and 5b, while the timings to clamp the plurality of molding dies 5a and 5b are synchronized, resin molding can be performed with the variations in thickness of the pre-molding substrate W and the like in the molding dies 5a and 5b being absorbed.

Further, the pantograph mechanism 81 is used to interlock the raising and lowering of the movable platen 3 and the raising and lowering of the intermediate plate 4. Accordingly, an increase in size of each member can be prevented and an increase in size of the entire device can be reduced. Thus, a high-rigidity member can be eliminated.

### 2. Second Embodiment of Present Invention

Next, a second embodiment of the present invention is described. It is to be noted that, in the following, parts different from the first embodiment are described, and the same member is denoted by the same reference symbol for description.

The resin molding apparatus 100 of the second embodiment has a configuration including, unlike the first embodiment (a configuration including two sets of molding dies using one intermediate plate 4), a plurality of sets of molding dies using a plurality of intermediate plates 4. For example, the resin molding apparatus 100 may have a configuration including three sets of molding dies using two intermediate plates 4, a configuration including four sets of molding dies using three intermediate plates 4, a configuration including five sets of molding dies using four intermediate plates 4, or further a configuration including six or more sets of molding dies using five or more intermediate plates 4.

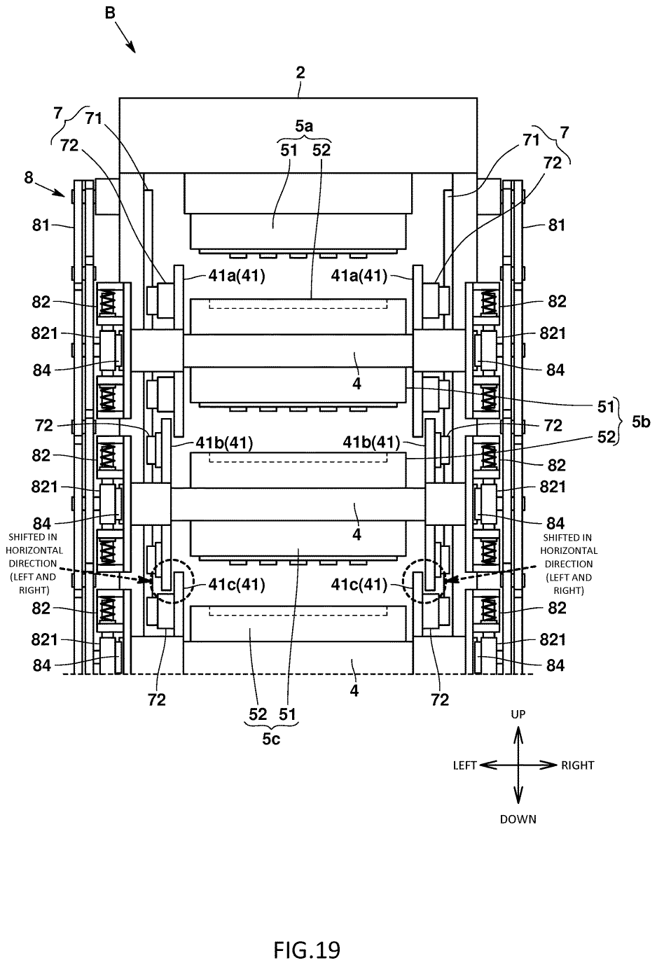

Specifically, in the resin molding apparatus 100, as illustrated in FIG. 19, a plurality of intermediate plates 4 are disposed along the up-down direction between the stationary platen 2 and the movable platen 3. Further, molding dies 5b and 5c each including the upper molding die 51 and the lower molding die 52 are provided between the plurality of intermediate plates 4. It is to be noted that FIG. 19 illustrates the configuration from the stationary platen 2 to the three intermediate plates 4, and illustration of a lower part therefrom is omitted.

Similarly to the first embodiment, each of the plurality of intermediate plates 4 is coupled to each of a plurality of cross-link portions 811 of the pantograph mechanism 81 via the coupling mechanism 82. This allows the plurality of intermediate plates 4 to be raised and lowered in association with the raising and lowering of the movable platen 3.

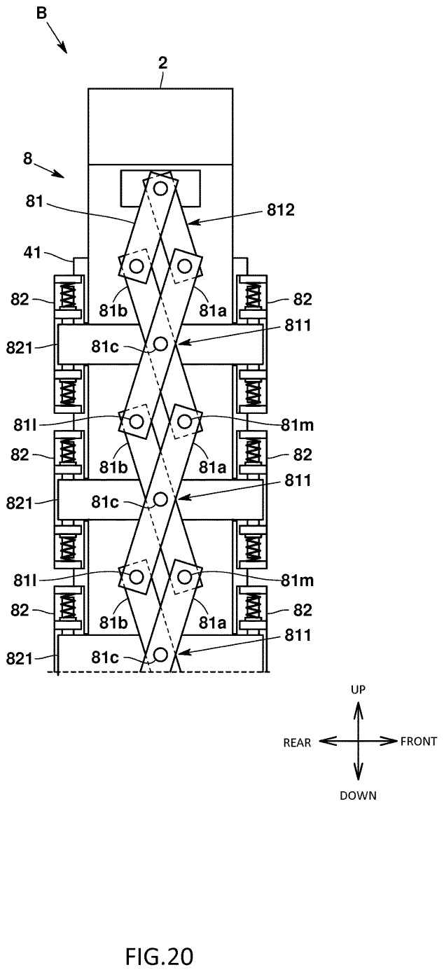

Here, the pantograph mechanism 81 is configured of, as illustrated in FIG. 20, a plurality of cross-link portions 811 in a number corresponding to the plurality of intermediate plates 4, the upper end link portion 812, and the lower end link portion 813. In addition, the plurality of cross-link portions 811 are connected in series. Specifically, in adjacent cross-link portions 811, an upper end portion of the first link 81a of one cross-link portion 811 is rotatably coupled to an upper end portion of the second link 81b of the other cross-link portion 811 by a rotary shaft 811, and an upper end portion of the second link 81b of the one cross-link portion 811 is rotatably coupled to an upper end portion of the first link 81a of the other cross-link portion 811 by a rotary shaft 81m. It is to be noted that the configurations of the upper end link portion 812 and the lower end link portion 813 are similar to the first embodiment.

Further, the side surface plates 41 respectively connected to the plurality of intermediate plates 4 are disposed to be shifted in the horizontal direction so as not to interfere with each other. Specifically, as illustrated in FIG. 19, the side surface plates 41 of the intermediate plates 4 adjacent to each other in the up-down direction are disposed to be shifted in the left-right (horizontal) direction so as to be staggered.

For example, a side surface plate 41a of the first intermediate plate 4 from the top is disposed to be positioned on the inner side, and a side surface plate 41b of the second intermediate plate 4 from the top is disposed to be positioned on the outer side. Further, the side surface plate 41b of the second intermediate plate 4 from the top is disposed to be positioned on the outer side, and a side surface plate 41c of the third intermediate plate 4 from the top is disposed to be positioned on the inner side. Here, the side surface plate 41b of the second intermediate plate 4 from the top has a through hole, a cutout portion, or the like which is not shown and formed over a movement range of the linear motion block 842 so as not to hinder the movement of the linear motion blocks 842 disposed on the side surface plates 41a and 41c (first and third from the top) positioned on the inner side.

### 2-1. Effect of Second Embodiment

With the resin molding apparatus 100 of this embodiment, in addition to the effects of the first embodiment, resin molding can be performed through use of three or more molding dies 5a to 5c, and thus the productivity of the resin molded product P can be improved. Further, the side surface plates 41 of the plurality of intermediate plates 4 are disposed to be shifted in the horizontal direction so as not to interfere with each other, and hence the height dimension of the resin molding apparatus 100 can be reduced.

### 3. Other Modification Embodiments

It is to be noted that the present invention is not limited to the embodiments.

For example, in the configuration of FIG. 2 and FIG. 3, another base member may be provided between the stationary platen 2 and the upper molding die 51 of the molding die 5a, between the intermediate plate 4 and the lower molding die 52 of the molding die 5a, between the intermediate plate 4 and the upper molding die 51 of the molding die 5b, or between the movable platen 3 and the lower molding die 52 of the molding die 5b.

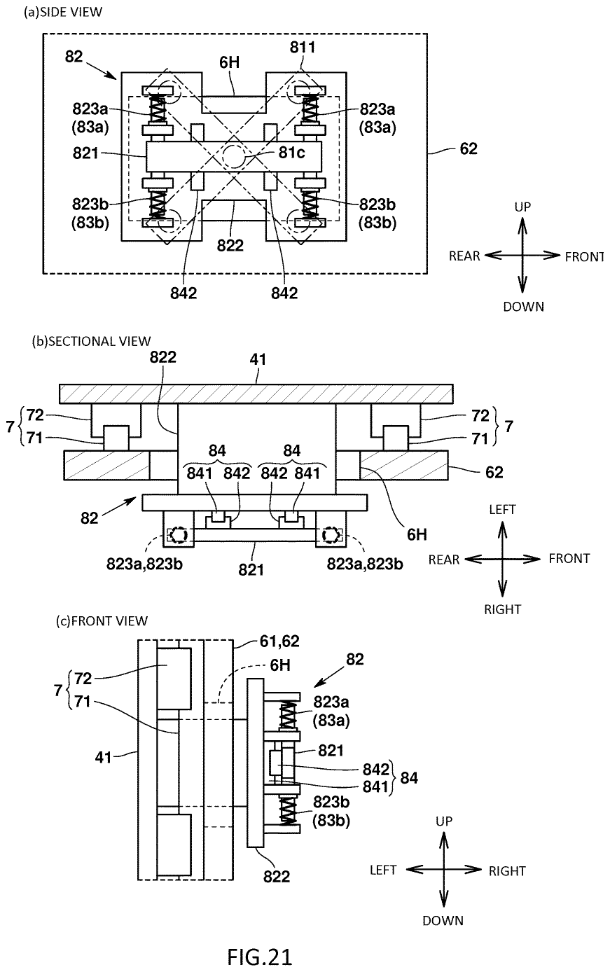

Further, in the embodiments, the coupling member 822 is configured to extend outside of the front and rear of each of the side wall members 61 and 62, but, as illustrated in FIG. 21, the embodiments may have a configuration in which the coupling member 822 and the connection member 821 are coupled through a through portion 6H formed in each of the side wall members 61 and 62.

Specifically, the through portion 6H is formed in a part of each of the side wall members 61 and 62 corresponding to the cross-link portion 811. Here, the through portion 6H is formed so as not to interfere with the movement of the coupling member 822 in consideration of the movement amount of the intermediate plate 4.

Further, the coupling member 822 is connected to the side surface plate 41 of the intermediate plate 4, and extends outside of the side wall member 61 or 62 through the through portion 6H of the side wall member 61 or 62, and supports the elastic members 823a and 823b (the displacement absorbing mechanisms 83a and 83b) on the outer side of the side wall member 61 or 62. With the elastic members 823a and 823b (the displacement absorbing mechanisms 83a and 83b), the coupling member 822 is coupled to the connection member 821.

Further, the guide mechanism 84 is provided between the connection member 821 and the coupling member 822. Specifically, the guide mechanism 84 includes the linear motion rail 841 provided on one of the connection member 821 or the coupling member 822, and the linear motion block 842 provided on the other of the connection member 821 or the coupling member 822.

The plurality of molding dies used in the first and second embodiments may be the same molding die as each other, or may be molding dies different from each other. Here, the plurality of molding dies different from each other may mean that the upper molding dies are different from each other, or the lower molding dies are different from each other.

In the embodiments, the linear motion rail 71 of the raising-lowering sliding mechanism 7 is provided on each of the side wall member 61 and 62, and the linear motion block 72 is provided on the side surface plate 41, but the linear motion rail 71 of the raising-lowering sliding mechanism 7 may be provided on the side surface plate 41, and the linear motion block 72 may be provided on each of the side wall members 61 and 62.

The embodiments have a configuration in which the plurality of molding dies 5a and 5b are interlocked by using the pantograph mechanism 81, but other types of raising-lowering interlocking mechanism 8 using a lever mechanism (Japanese Patent Laid-Open No. 2019-77144), a rack and pinion mechanism (Japanese Patent Laid-Open No. 2010-094931), and the like may also be used.

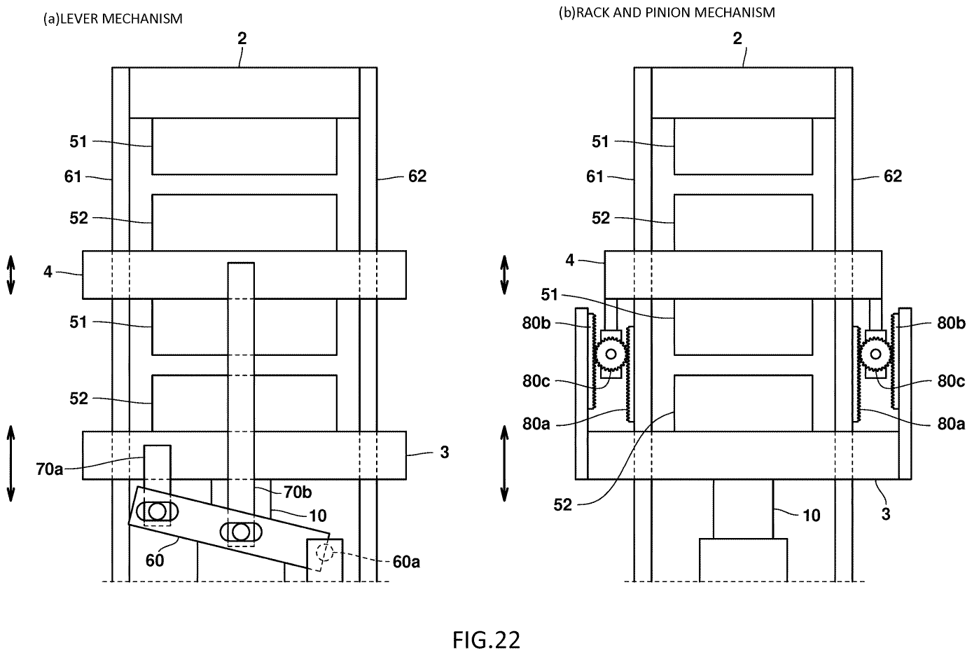

For example, as illustrated in FIG. 22(a), the raising-lowering interlocking mechanism 8 using the lever mechanism includes an arm 60 that rotates about one end portion serving as a fulcrum 60a, and the movable platen 3 and the intermediate plate 4 are coupled to the arm 60 at different positions via coupling members 70a and 70b. In addition, when the movable platen 3 is driven by the clamping mechanism 10, the arm 60 rotates around the fulcrum 60a along therewith, and the intermediate plate 4 coupled to the arm 60 moves up and down in association with the movable platen 3.

Further, the raising-lowering interlocking mechanism 8 using the rack and pinion mechanism includes, as illustrated in FIG. 22(b), a pair of rack gears 80a and 80b and a pinion gear 80c that meshes with the rack gears 80a and 80b, and one rack gear 80a is provided on each of the side wall members 61 and 62 and the other rack gear 80b is provided on the movable platen 3 side. In addition, the pinion gear 80c that meshes with the pair of rack gears 80a and 80b is provided on the intermediate plate 4 side. With the pinion gear 80c being rotated forward or backward by a motor which is not shown, the movable platen 3 and the intermediate plate 4 are moved in the up-down direction in association with each other.

The molding die in the embodiments includes a plurality of sets of upper molding dies 51 and lower molding dies 52, but may be configured to include a single set of an upper molding die 51 and a lower molding die 52. In this case, the base member is the stationary platen 2 and the movable platen 3. In addition, the molding die sliding mechanism 20 slides the upper molding die 51 in the sliding direction that intersects with the clamping direction relative to the stationary platen 2. Further, the molding die sliding mechanism 20 slides the lower molding die 52 in the sliding direction that intersects with the clamping direction relative to the movable platen 3.

In addition, the present invention is not limited to the embodiments, and it is needless to say that various modifications can be made thereto without departing from the gist thereof.

### INDUSTRIAL APPLICABILITY

According to the present invention, in the resin molding apparatus that slides the molding die in the sliding direction intersecting with the clamping direction, the wearing to be caused by sliding of the molding die can be reduced.

### REFERENCE SIGNS LIST

100 . . . Resin molding apparatus
W . . . Molding target
P . . . Resin molded product (resin-molded molding target)
J . . . Resin material
F . . . Mold release film
2 . . . Stationary platen (base member)
3 . . . Movable platen (base member)
4 . . . Intermediate plate (base member)
5a, 5b, 5c . . . Molding die
51 . . . Upper molding die
52 . . . Lower molding die
61, 62 . . . Pair of side wall members
7 . . . Raising-lowering sliding mechanism
81 . . . Pantograph mechanism
82 . . . Coupling mechanism
10 . . . Clamping mechanism
13 . . . Substrate conveying mechanism (molding target conveying mechanism)
X1 . . . Conveying position
131 . . . Substrate supplying unit (molding target supplying unit)
132 . . . Substrate receiving unit (molding target receiving unit)
18 . . . Resin material conveying mechanism
X2 . . . Conveying position
181 . . . Resin material supplying unit
182 . . . Film collecting unit
20 . . . Molding die sliding mechanism
201 (201a, 201b) . . . Support frame
Q . . . Clamping position
R . . . Protruding position
203 . . . Drive actuator
207 . . . Positioning portion
30 . . . Interval changing mechanism
301 . . . Cam mechanism

1. A resin molding apparatus comprising:
a clamping mechanism that clamps a molding die via a base member;
a molding die sliding mechanism that slides the molding die between a clamping position at which clamping is performed and a protruding position positioned on an outer side relative to the base member in a sliding direction intersecting with a clamping direction; and
an interval changing mechanism that changes an interval between opposing surfaces of the base member and the molding die when the molding die sliding mechanism slides the molding die between the clamping position and the protruding position.

2. The resin molding apparatus according to claim 1, wherein:
the molding die includes an upper molding die and a lower molding die;
the molding die sliding mechanism is provided to correspond to each of the upper molding die and the lower molding die; and
the interval changing mechanism is provided to correspond to each of the upper molding die and the lower molding die.

3. The resin molding apparatus according to claim 1, wherein the molding die sliding mechanism and the interval changing mechanism are configured through use of a common drive actuator.

4. The resin molding apparatus according to claim 1, wherein:
the molding die sliding mechanism includes:
a support frame that supports the molding die; and
a drive actuator that moves the support frame in the sliding direction;
the interval changing mechanism includes
a cam mechanism provided to be interposed between the molding die and the base member; and
the cam mechanism changes an interval between the opposing surfaces of the molding die and the base member along with movement of the support frame by the drive actuator.

5. The resin molding apparatus according to claim 1, wherein:
the interval changing mechanism keeps, at the clamping position, the opposing surfaces of the molding die and the base member in a state of having a gap without bringing the opposing surfaces into contact with each other; and
the opposing surfaces of the molding die and the base member come into contact with each other when the clamping mechanism performs clamping.

6. The resin molding apparatus according to claim 1, wherein the molding die sliding mechanism includes a positioning portion that comes into contact with the molding die that moves toward the clamping position to position the molding die at the clamping position.

7. The resin molding apparatus according to claim 1, wherein:
the base member includes:
a stationary platen;
a movable platen that can be raised and lowered by the clamping mechanism; and
an intermediate plate disposed between the stationary platen and the movable platen;
the molding die includes an upper molding die and a lower molding die respectively provided between the stationary platen and the intermediate plate and between the intermediate plate and the movable platen;
the resin molding apparatus further comprises:
a pair of side wall members disposed on both lateral sides of the movable platen and the intermediate plate;
a raising-lowering sliding mechanism that slides the intermediate plate along an up-down direction relative to the pair of side wall members; and
a raising-lowering interlocking mechanism that interlocks raising and lowering of the intermediate plate with raising and lowering of the movable platen; and
the raising-lowering interlocking mechanism includes:
a pantograph mechanism that includes one end portion fixed to the side wall member and another end portion that moves together with the movable platen, the pantograph mechanism expanding and contracting by the raising and lowering of the movable platen; and
a coupling mechanism that couples a cross-link portion of the pantograph mechanism and the intermediate plate.

8. The resin molding apparatus according to claim 1, further comprising a conveying mechanism that conveys a conveying target to the molding die present at the protruding position.

9. The resin molding apparatus according to claim 8, wherein the conveying mechanism includes:
a molding target conveying mechanism that conveys a molding target to the molding die present at the protruding position; and
a resin material conveying mechanism that conveys a resin material to the molding die present at the protruding position.

10. The resin molding apparatus according to claim 9, wherein the molding target conveying mechanism includes:
a molding target supplying unit that supplies the molding target to the molding die present at the protruding position; and
a molding target receiving unit that receives the molding target subjected to resin molding from the molding die present at the protruding position.

11. The resin molding apparatus according to claim 9, wherein the resin material conveying mechanism includes:
a resin material supplying unit that supplies the resin material to the molding die present at the protruding position; and
a film collecting unit that collects a used release film from the molding die present at the protruding position.

12. A resin molded product manufacturing method of manufacturing a resin molded product through use of the resin molding apparatus according to claim 1, the resin molded product manufacturing method comprising:
conveying a molding target to the molding die present at the protruding position;
performing resin molding on the molding target while clamping the molding die present at the clamping position; and
taking out the molding target subjected to the resin molding from the molding die present at the protruding position.
